(19) United States
(12) Patent Application Publication
(10) Pub. No.: US 2026/0253155 A1
(43) Pub. Date: Aug. 27, 2026

(54) IDEA AND INTELLECTUAL PROPERTY MANAGEMENT SYSTEM AND METHOD

(71) Applicant: NovaLexi, Inc., Lewes, DE (US)

(72) Inventor: Mohammad Nusair, Amman (JO)

(21) Appl. No.: 19/550,105

(22) Filed: Feb. 25, 2026

Related U.S. Application Data
(60) Provisional application No. 63/763,816, filed on Feb. 26, 2025.
(60) Provisional application No. 63/800,834, filed on May 6, 2025.

(51) Int. Cl. G06Q 50/18; G06Q 20/02

(52) U.S. Cl. CPC G06Q 50/184; G06Q 20/027

(57) ABSTRACT

The present disclosure relates to intellectual property (IP) management systems, and more particularly, to a scalable, multi-tenant platform for managing diverse IP assets with integrated artificial intelligence (AI), workflow automation, financial management, and interoperability with global IP databases and government systems. The intellectual property (IP) management computing system and method 100 disclosed herein brings together innovators, administrators, and IP agents to collaborate efficiently within one smart ecosystem. Each role is supported by customized dashboards, intelligent workflows, and AI-powered tools configured to optimize their specific tasks. Users move through the system from idea generation to filing, management, and IP protection, ensuring clarity and control at every stage. Real-time updates, shared access, task management, and communication tools, promote transparency, teamwork and faster execution. The computing system and method streamlines the entire innovation cycle capturing, nurturing, managing and safeguarding intellectual property.

### CROSS-REFERENCE TO RELATED APPLICATIONS

This application claims the benefit of U.S. Provisional Patent Application Ser. No. 63/763,816, filed Feb. 26, 2025 and U.S. Provisional Patent Application Ser. No. 63/800,834, filed May 6, 2025, which are hereby incorporated by reference in their entireties.

### FIELD OF THE DISCLOSURE

The present disclosure relates to systems and methods for managing intellectual property (IP) assets. The disclosed system is configured to coordinate tenant-isolated intellectual property asset records, dynamically instantiated workflows, automated verification with external government intellectual property systems, payment execution, document governance, and state transitions across an intellectual property asset lifecycle, with integrated artificial intelligence (AI).

### BACKGROUND OF THE DISCLOSURE

Intellectual property has become increasingly more important in today's global economy. Intellectual property can be viewed as a new type of currency in this economy because it is now more easily translatable to value, and vehicles for ownership of that intellectual property such as patents and trademarks, can store that value. Accordingly, even in fast-moving industries, intellectual property rights which cover core technology can be very valuable, even for an extended period of time. Intellectual property is also valuable as a revenue generator. However, the patent process is very expensive and slow moving. Furthermore, patents remain one of the most underutilized assets in a company's portfolio. This is due, at least in significant part, to the fact that patent analysis and tracking, whether for purposes of prosecution, licensing, infringement, enforcement, technical research, product development, etc., is a very difficult, tedious, time consuming, and expensive task.

### SUMMARY

Aspects of the disclosure include an intellectual property (IP) management system comprising one or more processors and non-transitory computer-readable media storing instructions that, when executed, cause the system to: provision an isolated tenant environment and import IP asset data including jurisdiction-specific attributes and deadlines into the environment; link the imported IP asset data to tenant-customized visual workflow templates to automatically execute sequenced tasks, monitor deadlines, and trigger status transitions based on asset attributes; enforce secure agent-tenant collaboration by applying role-based access control and multi-factor authentication to permit agents to interact only with assigned workflows, tasks, and documents within the isolated environment while logging all actions immutably; integrate artificial intelligence (AI) to ingest research inputs from the tenant environment, generate draft IP filings and summaries of asset records and workflow statuses, and provide conversational reporting of real-time analytics; wherein the provisioning, workflow linking, access enforcement, and artificial intelligence (AI) integration cooperatively interact to form a closed-loop system in which imported asset data automatically instantiates workflow instances, workflow state transitions generate role-filtered notifications and controlled collaboration tasks, agent interactions update asset and workflow states, and refreshed asset data is supplied to the AI module to generate updated summaries and draft documentation that is routed back into active workflows for review and approval.

Further aspects of the disclosure include a computer-implemented method for managing intellectual property (IP) assets in a multi-tenant platform, comprising: provisioning isolated tenant environments with customizable workflows and attributes; importing a plurality of IP assets into the tenant environments from structured file formats; storing and tracking the plurality of IP assets by asset type, jurisdiction, and renewal deadline; and defining and executing workflow templates associated with each of the plurality of assets.

Further aspects of the disclosure include a computing system for intellectual property (IP) management, comprising: one or more processors and non-transitory computer-readable media storing instructions that, when executed, cause the system to implement: an IP agent management module that includes a dedicated agent portal; a controlled collaboration model executed within the agent portal, wherein the controlled collaboration model is configured to enable secure, role-specific interaction between IP agents and one or more tenants while enforcing strict controlled access boundaries, the boundaries comprising: (a) multi-tenant isolation, wherein data, workflows, documents, and communications belonging to any one tenant are stored and processed in a logically and physically segregated environment that is inaccessible to agents or users associated with any other tenant; (b) role-based access control (RBAC), wherein each agent is assigned one or more discrete roles including a filing agent, renewal specialist, and portfolio reviewer and is granted permissions only to the specific IP assets, workflows, tasks, and client communications that are explicitly assigned to that agent and that tenant; (c) limited visibility, wherein the agent portal displays to each agent only the subset of tenant information, documents, status data, payment records, and audit entries that is necessary for the performance of the agent's assigned role and assigned tasks, while automatically redacting or hiding all other tenant data, including data belonging to other tenants and non-relevant data within the same tenant; and (d) full auditability, wherein every action performed inside the agent portal is automatically and immutably logged with timestamp, actor identity, role, tenant identifier, IP asset reference, and before and after values, and the resulting audit trail is stored in a tamper-evident repository accessible only to authorized super-administrators or compliance officers.

### BRIEF DESCRIPTION OF THE DRAWINGS

Aspects of the embodiments of this disclosure are illustrated by way of example. While various details of one or more techniques are described herein, other techniques are also possible. In some instances, well-known structures and devices are shown in block diagram form in order to facilitate describing various techniques. A further understanding of the nature and advantages of examples provided by the disclosure can be realized by reference to the remaining portions of the specification and the drawings, wherein like reference numerals are used throughout the several drawings to refer to similar components. In some instances, a sub-label is associated with a reference numeral to denote one portion or part of a larger element or one of multiple similar components. When reference is made to a reference numeral without specification to an existing sub-label, the reference numeral refers to all such similar components.

FIG. 1 illustrates a number of electronic systems and devices communicating with each other in a network environment in accordance with an IP management computing system 100 embodiment.

FIG. 2 is a block diagram of a cloud computing system in which embodiments of the present technique may operate.

FIG. 3 depicts a diagram of an example logical flow of an enterprise generative artificial intelligence system according to some embodiments.

FIG. 4 depicts a diagram of an exemplary layered architecture and environment of an enterprise generative artificial intelligence system according to some embodiments.

FIG. 5 depicts a diagram of the IP management computing system and method 100 with an architecture of a specialized enterprise generative artificial intelligence system.

FIG. 6 depicts a diagram of the IP management computing system and method 100 as an exemplary specialized enterprise generative artificial intelligence system.

FIG. 7 discloses a method of use of the IP management computing system 100.

FIG. 8 discloses an administrative panel 800 or IP management computing system 100.

FIG. 9 discloses an IP service management module 900.

FIG. 10A and10B disclose workflow management modules including an administrative module 1000A and a tenants module 1000B.

FIG. 11 discloses a notion-style lab notebook module 1100.

FIG. 12 discloses an intellectual property maintenance module 1200 configured to manage renewal and annuity obligations across multiple jurisdictions by periodically querying external government intellectual property systems, comparing retrieved status data against stored asset lifecycle states, and programmatically instantiating renewal workflows upon detection of renewal conditions. The module calculates applicable government and agent fees, initiates payment execution through an integrated financial module, and updates asset states upon confirmation of payment, with all renewal-related actions recorded in an immutable audit trail.

FIG. 13 discloses a reports module 1300 configured to aggregate data across IP asset records, workflow execution states, renewal events, financial transactions, and audit logs to generate compliance-ready reports, portfolio analytics, and system performance visualizations.

FIG. 14A discloses an artificial intelligence module 1400 configured to generate draft IP filings, summaries, and analytics by applying generative artificial intelligence techniques to tenant-isolated data, wherein AI-generated outputs are constrained by workflow state, access control policies, and document governance rules prior to insertion into active workflows or governed repositories. FIG. 14B illustrates an AI-assisted prior art search flow.

FIG. 15 discloses an IP agent management module 1500 configured to manage interactions between tenants and assigned agents, enforce role-based access controls, and restrict agent visibility to only those assets, documents, and workflows explicitly assigned to the agent.

FIG. 16 discloses a financial management module 1600 configured to process payments associated with IP services, renewals, annuities, and licensing transactions, differentiate between government-imposed fees and agent service fees, and associate each transaction with corresponding IP assets, workflow instances, and audit records.

FIG. 17 discloses a user security and access control module 1700 configured to enforce role-based access control, multi-factor authentication, document-level access policies, and tenant isolation, wherein all access decisions generate immutable audit records.

FIG. 18 discloses a communication and support module 1800 configured to facilitate secure, asset-linked communications between tenants, agents, and administrators, wherein messages and support interactions are associated with specific IP assets and workflows.

FIG. 19 discloses a DevOps and deployment module configured to deploy the IP management system on containerized cloud infrastructure while enforcing data residency, availability, and compliance requirements across tenant environments.

FIG. 20 discloses a trade secret vault subsystem 2000 with controlled access and audit tracking.

FIG. 21 shows the trade secret vault system 2000 interaction with other modules in the system 100.

FIG. 22 discloses the trade secret vault access workflow.

### DETAILED DESCRIPTION OF THE DISCLOSURE

Intellectual property owners, agents, and organizations face increasing complexity in tracking, maintaining, and commercializing IP assets such as patents, trademarks, copyrights, and industrial designs. Existing IP management solutions are often fragmented, lack scalability, limited in automation, and insufficiently integrated with global IP authorities and payment gateways, especially in jurisdictions with limited or no open APIs for status checks and renewals. Further, existing systems lack a coordinated technical architecture capable of enforcing tenant isolation while programmatically instantiating asset-specific workflows, verifying asset status with disparate government systems, managing secure document-level access controls, and automatically transitioning lifecycle states based on verified events. Moreover, manual tracking of renewals, annuities, and compliance obligations introduces risks of missed deadlines, financial penalties, and asset loss. There is a need for a technically integrated system configured to automate workflow instantiation, government status verification, renewal event detection, secure document governance, and structured research-to-filing pipelines within a multi-tenant architecture. (Workflow as used herein is a series of activities that are necessary to complete a task. Each step in a workflow has a specific step before it and a specific step after it, except for the first and last steps) . There is a need as well for an integrated IP management platform that is scalable across multiple tenants, customizable by asset type, and equipped with artificial intelligence (AI)-powered functionality, secure payment handling, and global integration with government IP systems, including periodic status verification and automatic workflow transitions based on verified office updates. This disclosure provides a scalable, multi-tenant IP management system (or platform) and method configured to register, manage, and maintain diverse IP assets within secure tenant environments. Each tenant operates in an isolated data environment and may provision IP services, workflows, and agents through an administrative portal. In addition, there is disclosed a system where users can visualize and manage their IP assets, making it easier to understand what they have and the potential for commercialization. The system and method implements AI-powered analytics for efficient IP asset management, integrates global IP databases and payment gateways and provides a secure, self-service platform for tenants that integrates IP agents. The system enables periodic government status verification in fragmented jurisdictions, automated renewal monitoring, and workflow transitions triggered by verified status changes or payment confirmations. In particular, the system periodically queries one or more external government intellectual property systems, compares retrieved status data against stored asset lifecycle states, and automatically instantiates renewal workflows and state transitions upon detection of a renewal condition and confirmation of payment execution. One or more specific embodiments will be described below. In an effort to provide a concise description of these embodiments, not all features of an actual implementation are described in the specification.

The intellectual property (IP) management computing system and method 100 disclosed herein may be referred to as the “computing system,” the “platform,” or the “IP management system.”

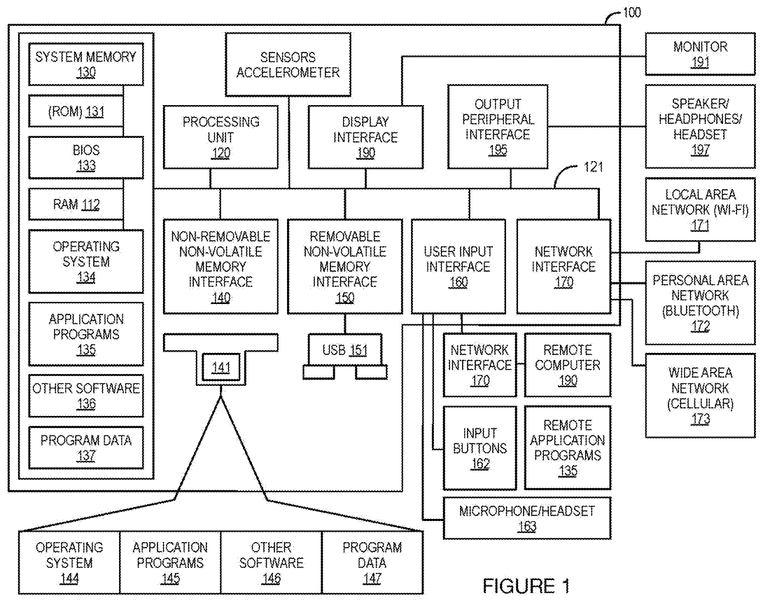

FIGS. 1-6 relate to various types of generalized system architectures or configurations that may be employed to provide services to an organization in a multi-instance platform and on which the present approaches for intellectual property management may be employed. Correspondingly, these system and platform examples may also relate to systems and platforms on which the techniques discussed herein may be implemented or otherwise utilized. In contrast to generic enterprise architectures, the computing system and method 100 enforces tenant-isolated data environments and event-driven coordination between workflow execution, government status verification, document governance, and financial transaction modules.

FIG. 1 illustrates a computing system and method 100 that can be, wholly or partially, part of one or more of a server or client computing devices in accordance with embodiments disclosed herein. As used herein, the terms “module”, “application”, “engine”, “program”, or “plugin” refers to one or more sets of computer software instructions (e.g., computer programs and/or scripts) executable by one or a plurality of processors of a computing system to provide particular functionality. Computer software instructions can be written in any suitable programming languages, such as C, C++, C#, Pascal, Fortran, Perl, MATLAB, SAS, SPSS, JavaScript, AJAX, JAVA and Python. Such computer software instructions can comprise an independent application with data input and data display modules. Alternatively, the disclosed computer software instructions can be classes that are instantiated as distributed objects. Additionally, the disclosed applications, modules or engines can be implemented in computer software, computer hardware, or a combination thereof. As used herein, the terms “system”, “platform”, and “framework” refer to a system of applications, and/or engines, as well as any other supporting data structures, libraries, modules, and any other supporting functionality, that cooperate to perform one or more overall functions.

With reference to FIG. 1, components of the computing system and method 100 can include, but are not limited to, a processing unit 120 having one or more processing cores, a system memory 130, and a system bus 121 that couples various system components including the system memory 130 to the processing unit 120. The system bus 121 may be any of several types of bus structures selected from a memory bus or memory controller, a peripheral bus, and a local bus using any of a variety of bus architectures.

Computing system and method 100 includes a variety of computing machine-readable media. Computing machine-readable media can be any available media that can be accessed by computing system and method 100 and includes both volatile and nonvolatile media, and removable and non-removable media. The system memory 130 includes computer storage media in the form of volatile and/or nonvolatile memory such as read only memory (ROM) 131 and random access memory (RAM) 132. A basic input/output system 133 (BIOS) is typically stored in ROM 131. By way of example, and not limitation, computing machine-readable media use includes storage of information, such as computer-readable instructions, data structures, other executable software or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing system and method 100. Communication media typically embody computer readable instructions, data structures, other executable software, or other transport mechanism and includes any information delivery media. As an example, some client computing systems on a network might not have optical or magnetic storage. RAM 132 typically contains data and/or software that are immediately accessible to and/or presently being operated on by the processing unit 120. The RAM 132 can include a portion of the operating system 134, application programs 135, other executable software 136, and program data 137. The computing system and method 100 can also include other removable/non-removable volatile/nonvolatile computer storage media. By way of example only, FIG. 1 illustrates a memory 141 and a non-removable non-volatile memory interface 140. Other removable/non-removable, volatile/nonvolatile computer storage media that can be used in the example operating environment include, but are not limited to, a universal serial bus (USB) 151, flash memory, RAM, or ROM. USB 151 is typically connected to the system bus 121 by a removable memory interface, such as interface 150. In FIG. 1, for example, the memory 141 is illustrated for storing operating system 144, application programs145, other executable software 146, and program data 147. Operating system 144, application programs 145, other executable software 146, and program data 147 are given different numbers.

A user may enter commands and information into the computing system and method 100 through input devices such as a keyboard, touchscreen, or software or hardware input buttons 162, a microphone 163, a pointing device and/or scrolling input component, such as a mouse, trackball or touch pad. The microphone 163 can cooperate with speech recognition software. These and other input devices are often connected to the processing unit 120 through a user input interface 160 that is coupled to the system bus 121, but can be connected by other interface and bus structures, such as a parallel port, or a universal serial bus (USB). A display monitor 111 or other type of display screen device is also connected to the system bus 121 via an interface, such as a display interface 110. In addition to the monitor 111, computing devices may also include other peripheral output devices such as speakers 117 and other output devices, which may be connected through an output peripheral interface 115.

The computing system and method 100 can operate in a networked environment using logical connections to one or more remote computers/client devices, such as a remote computing system 160. The remote computing system 160 can be a personal computer, a hand-held device, a server, a router, a network PC, a peer device or other common network node, and typically includes many or all of the elements described above relative to the computing system and method 100.

FIG. 1 illustrates remote application programs 185 as residing on remote computing device 160. The logical connections depicted in FIG. 1 can include a personal area network (“PAN”) 172 (e.g., Bluetooth®), a local area network (“LAN”) 171 (e.g., Wi-Fi), and a wide area network (“WAN”) 173 (e.g., cellular network), but may also include other networks. Such networking environments are commonplace in offices, enterprise-wide computer networks, intranets and the Internet. A browser application may be resident on the computing device and stored in the memory.

When used in a LAN networking environment, the computing system 100 is connected to the LAN 171 through a network interface or adapter 170, which can be, for example, a Bluetooth® or Wi-Fi adapter. When used in a WAN networking environment (e.g., Internet), the computing system and method 100 typically includes some means for establishing communications over the WAN 173. It should be noted that the present configuration can be carried out on a computing system 100 such as that described with respect to FIG. 1. However, the present configuration can be carried out on a server, a computing device devoted to message handling, or on a distributed system in which different portions of the present design are carried out on different parts of the distributed computing system.

In an exemplary embodiment, software used to facilitate processes and methods 100 discussed herein can be embodied onto a non-transitory machine-readable medium. A machine-readable medium includes any mechanism that stores information in a form readable by a machine (e.g., a computer). For example, a non-transitory machine-readable medium can include read only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, the computer system and method 100 described herein includes but is not limited to software applications, mobile apps, and programs that are part of an operating system application. A process is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These processes can be written in a number of different software programming languages such as PYTHON™, JAVA™, HTTP, C, C+, or other similar languages. Also, a process can be implemented with lines of code in software, configured logic gates in software, or a combination of both. In an embodiment, the logic consists of electronic circuits that follow the rules of Boolean Logic, software that contain patterns of instructions, or any combination of both. Many functions performed by electronic hardware components can be duplicated by software emulation. Thus, a software program written to accomplish those same functions can emulate the functionality of the hardware components in input-output circuitry.

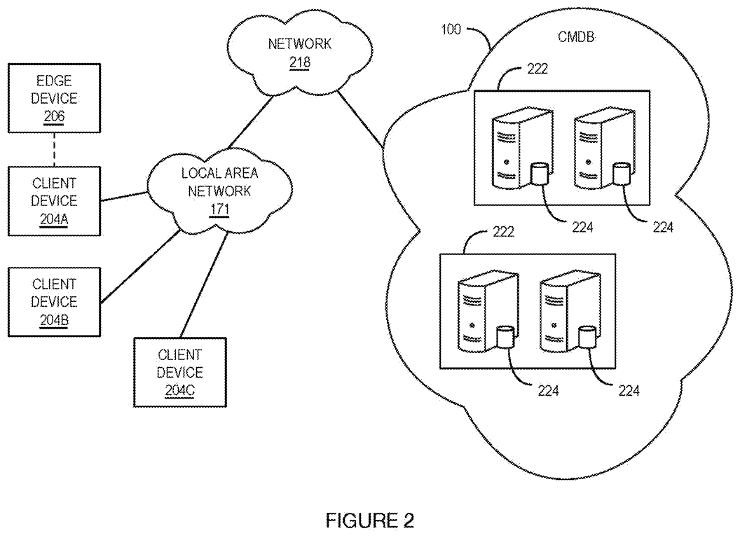

FIG. 2 is a block diagram of an embodiment of a cloud computing system in which embodiments of the computing system and method 100 may operate. Computing system and method 100 may be a cloud based platform connected to local area network 171 and network 218 (e.g., the Internet). In one embodiment, the local area network 171 may a variety of network devices that include, but are not limited to, have switches, servers, and routers. As shown in FIG. 2, the local area network 171 is able to connect to one or more client devices 204A, 204B, and 204C so that the client devices are able to communicate with each other and/or with the network hosting the platform 100. The client devices 204A-C may be computing systems and/or other types of computing devices generally referred to as Internet of Things (IoT) devices that access cloud computing services, for example, via a web browser application or via an edge device 206 that may act as a gateway between the client devices and the platform 100. FIG. 2 also illustrates that the local area network 171 includes an administration or managerial device or server, such as a management, instrumentation, and discovery (MID) server 207 that facilitates communication of data between the network hosting the platform 100, other external applications, data sources, and services, and the local area network 171.

FIG. 2 illustrates that client network 208 is coupled to network 218. The network 218 may include one or more computing networks, such as other LANs, wide area networks (WAN), the Internet, and/or other remote networks, to transfer data between the client devices 204A-C and the network hosting the platform 100. Each of the computing networks within network 218 may contain wired and/or wireless programmable devices that operate in the electrical and/or optical domain.

In FIG. 2, the network hosting the platform 100 may be a remote network (e.g., a cloud network) that is able to communicate with the client devices 204A-C via the client network 208 and network 218. The network hosting the platform 100 provides additional computing resources to the client devices 204A-C and/or client network208. For example, by utilizing the network hosting the platform 100, users of client devices 204A-C are able to build and execute applications for various enterprise, IT, and/or other organization-related functions. In one embodiment, the network hosting the platform 100 is implemented on one or more data centers 222, where each data center could correspond to a different geographic location. Each of the data centers 222 includes a plurality of virtual servers 224, where each virtual server can be implemented on a physical computing system, such as a single electronic computing device (e.g., a single physical hardware server) or across multiple-computing devices (e.g., multiple physical hardware servers). Examples of virtual servers 224 include, but are not limited to a web server (e.g., a unitary web server installation), an application server (e.g., unitary JAVA Virtual Machine), and/or a database server, e.g., a unitary relational database management system (RDBMS) catalog.

To utilize computing resources within the platform 100, network operators may choose to configure the data centers 222 using a variety of computing infrastructures. In one embodiment, one or more of the data centers 222 are configured using a multi-tenant cloud architecture, such that one of the server instances 224 handles requests from and serves multiple customers. Data centers with multi-tenant cloud architecture commingle and store data from multiple customers, where multiple customer instances are assigned to one of the virtual servers 224. In a multi-tenant cloud architecture, the particular virtual server 224 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 224 causing outages for all customers allocated to the particular server instance.

In another embodiment, one or more of the data centers 222 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 224, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 100, and customer-driven upgrade schedules.

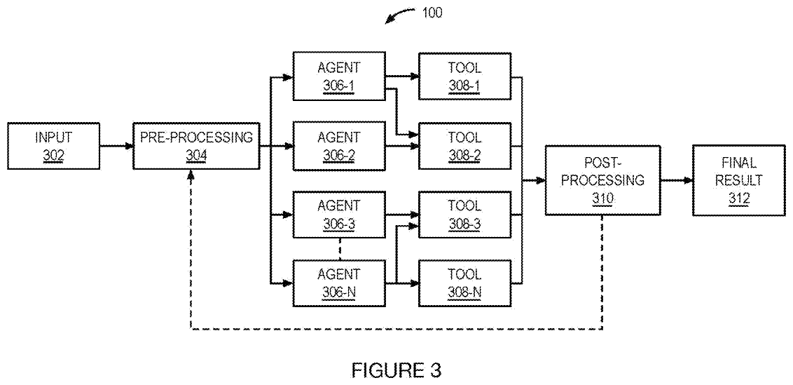

FIG. 3 depicts a diagram of the computer system and method 100 implemented in an specialized enterprise generative artificial intelligence system according to some embodiments. Artificial intelligence (AI) is a branch of computer science for the development of software that allows computer systems to perform tasks that imitate human cognitive intelligence, such as visual perception, speech recognition, decision-making, and language translation. Traditional approaches for storing and retrieving information typically involves databases and applications to index search and locate specific files. Generative AI is an artificial intelligence technology that uses machine learning algorithms to perform tasks that imitate human cognitive intelligence and generate content. Content can be in the form of text, audio, video, images, and more. Content in enterprise computing environments is typically spread across disparate data sources that may be incompatible, siloed, and access controlled. In the context of IP management, generative AI is applied to convert research notes into structured draft filings, generate summaries of IP records, and provide conversational interfaces for reporting on portfolio analytics. The generative artificial intelligence functions are constrained to operate on tenant-isolated data and are invoked by workflow events, asset state changes, or user-initiated actions within the IP management system.

A specialized enterprise generative artificial intelligence system can further use a combination of agents and tools to efficiently process a wide variety of inputs received from disparate data sources (e.g., having different data formats) and return results in a common data format. The enterprise generative artificial intelligence architecture includes an orchestrator agent (or, simply, orchestrator) that supervises, controls, and/or otherwise administrates many different agents and tools. Orchestrators can include one or more machine learning models and can execute supervisory functions, such as routing inputs (e.g., queries, instruction sets, natural language inputs or other human-readable inputs, machine-readable inputs) to specific agents to accomplish a set of prescribed tasks (e.g., retrieval requests prescribed by the orchestrator to answer a query). As used herein, “machine learning” or “ML” may be used to refer to any suitable statistical form of artificial intelligence capable of being trained using machine learning techniques, including supervised, unsupervised, and semi-supervised learning techniques. Machine learning models can include some or all of the different types or modalities of models described herein (e.g., multimodal machine learning models, large language models, data models, statistical models, audio models, visual models, audiovisual models, etc.). For example, in certain embodiments, ML-based techniques may be implemented using an artificial neural network (ANN) (e.g., a deep neural network (DNN), a recurrent neural network (RNN), a recursive neural network, a feedforward neural network). In contrast, “rules-based” methods and techniques refer to the use of rule-sets and ontologies (e.g., manually-crafted ontologies, statistically-derived ontologies) that enable precise adjudication of linguistic structure and semantic understanding to derive meaning representations from utterances. As used herein, a “vector” refers to a linear algebra vector that is an ordered n-dimensional list (e.g., a 300 dimensional list) of floating point values (e.g., a 1×N or an N×1 matrix) that provides a mathematical representation of the semantic meaning of a word or phrase, an intent, an entity, a token or an utterance. ML-based methods, perform well (e.g., better than rule-based methods) when a large corpus of data is available for analysis and training. The ML-based methods have the ability to automatically “learn” from the data presented to recall over “similar” input. Unlike rule-based methods, ML-based methods do not involve cumbersome hand-crafted features-engineering, and ML-based methods can support continued learning (e.g., entrenchment). However, it is recognized that ML-based methods struggle to be effective when the size of the corpus is insufficient. Additionally, ML-based methods are opaque (e.g., not easily explained) and are subject to biases in source data. Furthermore, while an exceedingly large corpus may be beneficial for ML training, source data may be subject to privacy considerations that run counter to the desired data aggregation.

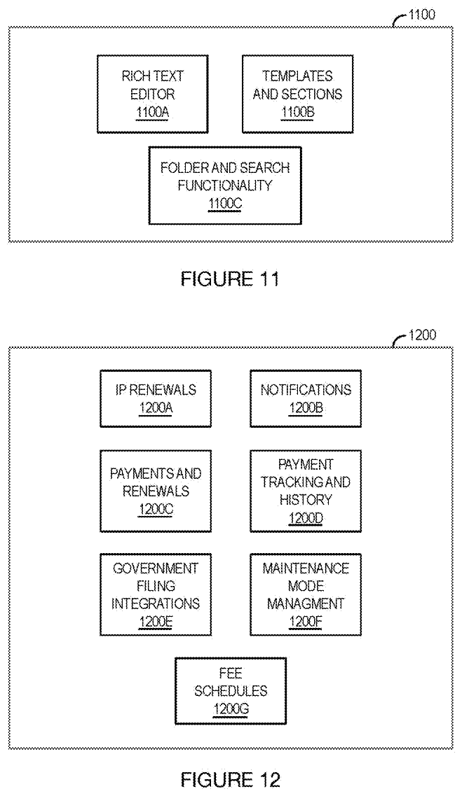

Agents can include one or more multimodal models (e.g., large language models) to accomplish the prescribed tasks using a variety of different tools. Different agents can use various tools to execute and process unstructured data retrieval requests, structured data retrieval requests, application programming interface (API) calls (e.g., for accessing artificial intelligence application insights), and the like. Tools can include one or more specific functions and/or machine learning models to accomplish a given task (or set of tasks). In IP management, tools facilitate, for example, notebook entry extraction for draft generation and workflow routing. At the core of the innovation cycle is the collaborative lab notebook module (shown as reference 1100 in FIG. 11). This module serves as the primary ingestion point for IP creation. It allows for structured capture in which users document research, equations, and images within a rich-text environment. The notebook also has an AI extraction engine which is a specialized agent utilizes Large Language Models (LLMs) to perform structured extraction of key technical elements (e.g., novelty, utility, claims) from the research notes. Also, the notebook module includes automated draft generation in which the system 100 maps extracted elements into jurisdiction-specific templates to generate initial drafts for patents, trademarks, and copyrights. Further, upon generation of a draft document, the notebook module programmatically transmits the draft to the workflow module to instantiate a corresponding filing workflow and routes the draft to the IP agent portal for role-specific professional review, modification, and submission.

Agents can adapt to perform differently based on contexts. A context may relate to a particular domain (e.g., industry) and an agent may employ a particular model (e.g., large language model, other machine learning model, and/or data model) that has been trained on industry-specific datasets, such as IP datasets. The particular agent can use an IP model when receiving inputs associated with an IP environment and can also easily and efficiently adapt to use a different model based on different inputs or context. Indeed, some or all of the models described herein may be trained for specific domains in addition to, or instead of, more general purposes. The specialized enterprise generative artificial intelligence architecture leverages domain specific models to produce accurate context specific retrieval and insights.

The orchestrator manages the agents to efficiently process disparate inputs or different portions of an input. For example, an input may require the system to access and retrieve data records from disparate data sources (e.g., unstructured datastores, structured datastores, timeseries datastores, and the like), database tables from different types of databases, and machine learning insights from different machine learning applications. The different agents can each separately, and in parallel, handle each of these requests, greatly increasing computational efficiency. Agents can process the disparate data returned by the different agents and/or tools. For example, large language models typically receive inputs in natural language format. The agents may receive information in a non-natural language format (e.g., database table, image, audio) from a tool and transform it into natural language describing the tool output in a format understood by large language models. A large language model can then process that input to “answer,” or otherwise satisfy the initial input. In IP contexts, this enables transformation of notebook entries into draft filings

FIG. 3 depicts a diagram of the computer system and method 100 of an exemplary logical flow of a specialized enterprise generative artificial intelligence system according to some embodiments. The computing system and method 100 is a multi-tenant environment designed to manage the full innovation lifecycle. In this environment, lifecycle events associated with intellectual property assets, documents, and workflows are processed through an orchestrated event-driven pipeline rather than isolated AI queries. Unlike generic AI wrappers, the computer system and method 100 utilizes a domain-specific orchestrator to manage isolated tenant data and execute IP-specific tasks. As shown, an initial input 302 is received by the system 100 from either a user (e.g., a natural language input) or another system (e.g., a machine-readable input). An orchestrator agent (or, simply, orchestrator) can pre-process the input in step 304. Pre-processing can include, for example, acronym handling, translation handling, punctuation handling, input identification (e.g., identifying different portions of the input 302 for processing by different agents). The orchestrator can use a multimodal model (e.g., large language model) to further process the input 302 to create a plan for determining a result (step 312) for the input. The plan may include a prescribed set of tasks, such as structured data retrieval tasks, unstructured data retrieval tasks, timeseries processing tasks, visualization tasks, and the like. In some embodiments, the plan can designate which tools 308 should be used to execute the tasks, and the orchestrator can select the agents based on the designated tools. In some embodiments, the plan can designate which agents should be used to execute the tasks, and the agents can independently designate which tools 308 should be used to execute the tasks. The orchestrator routes the pre-processed input to agents 306 for further processing. More specifically, the orchestrator may use one or more multimodal models (e.g., language, video, audio, statistical models, etc.), and/or other machine learning models, to interpret the input 302 to select appropriate agents 306 and appropriate tools 308. For example, the orchestrator may determine that a first portion of the input requires a database query, while another portion of the input requires an application programming interface (API) call. The orchestrator can appropriately route the first portion of the input to the appropriate agent 306-1 (e.g., a structured data retrieval agent) and route the second portion of the input to another agent 306-2 (e.g., API agent). There could be any number of such agents 306 accessing any number of different tools 308. The orchestrator may also instruct the agents 306 to operate in parallel and/or serially.

The agents 306 can select the appropriate tools 308 to accomplish a set of prescribed tasks (e.g., tasks prescribed by the orchestrator). The tools 308 can make the appropriate function calls to retrieve disparate data records among other functions. As used herein, data records can include unstructured data records (e.g., documents and text data that is stored on a file system in a format such as PDF, DOCX, .MD, HTML, TXT, PPTX, image files, audio files, video files, application outputs, and the like), structured data records (e.g., database tables or other data records stored according to a data model or type system), timeseries data records (e.g., sensor data, artificial intelligence application insights), and/or other types of data records (e.g., access control lists). The agents 306 can transform the disparate data records into a common format (e.g., natural language format) that can be post-processed (step 310) by a large language model (e.g., the same or different large language model that performed the pre-processing). More specifically, post-processing can take tool outputs (and/or transformed tool outputs) and generate a final result (step 312) that satisfies the initial input. For example, the orchestrator may use one or more large language models to determine the result. If the orchestrator determines there is not enough information to satisfy the initial input, the orchestrator can iteratively repeat some or all of the above steps until a stopping condition is satisfied and/or there is enough information to generate a final result (step 312).

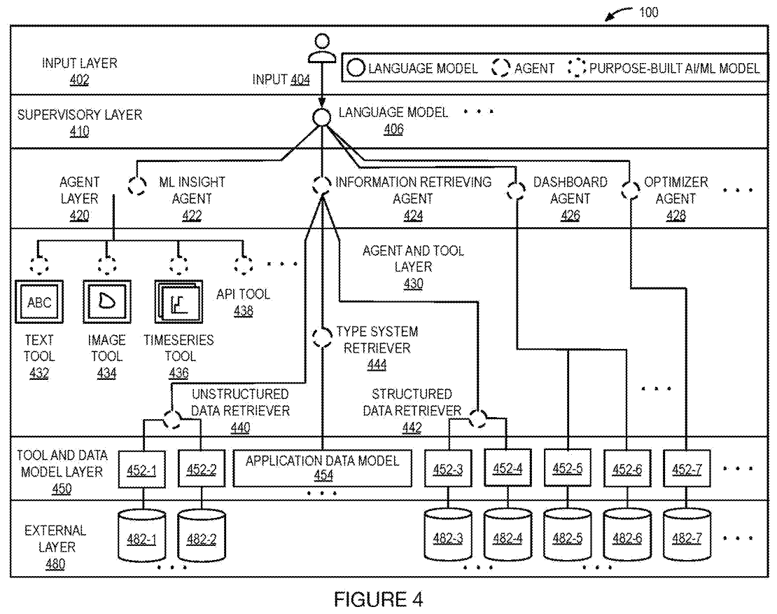

FIG. 4 depicts a diagram of the computer system and method 100 with an exemplary layered architecture and environment of a specialized enterprise generative artificial intelligence system according to some embodiments. The specialized enterprise software computer system and method 100 sits on top of a large language model (LLM) backbone, but not in the same way a traditional application uses a database. The large language model backbone augments, but does not replace, deterministic workflow execution, access control enforcement, document governance, and lifecycle state management performed by the IP management system. The LLM acts as an intelligent layer or “brain” that augments existing systems rather than replacing them entirely. This architecture is designed to add powerful natural language processing and generation capabilities to established enterprise processes and data. The specialized enterprise generative artificial intelligence system architecture and environment includes a hierarchy of layers. More specifically, the hierarchy of layers includes an input layer 402, a supervisory layer 410, an agent layer 420, an agent and tool layer 430, a tool and data model layer 450, and an external layer 460. It will be appreciated that these layers are shown by way of example, and other examples can include any number of such layers (e.g., any number of layers 420 and 430). The input layer 402 represents a layer of the enterprise generative artificial intelligence system architecture that receives an input (e.g., a query, complex input, instruction set, and/or the like) from a user or system. For example, an interface module of the enterprise generative artificial intelligence system may receive the input. The supervisory layer 410 represents a layer of the enterprise generative artificial intelligence system architecture that includes one or more large language models (e.g., of an orchestrator module) that can develop a plan for responding to the input received in the input layer 402. A plan can include a set of prescribed tasks (e.g., retrieval tasks, API call tasks, and the like). In one example, the supervisory layer 410 can provide pre-processing and post-processing functionality described herein as well as the functionality of the orchestrators and comprehension modules described herein. The supervisory layer 410 can coordinate with one or more of the subsequent layers 420-460 to execute the prescribed set of tasks. The agent layer 420 represents a layer of the enterprise generative artificial intelligence system architecture that includes agents that can execute the prescribed set of tasks. In the example of FIG. 4, the agent layer 420 includes a machine learning insight agent 422, an information retrieving agent 424, a dashboard agent 426, and an optimizer agent 428. Each of the agents 424-428 can include a large language model that provides reasoning functionality for accomplishing their assigned portion of the prescribed set of tasks. More specially, the agents 424-428 can instruct the agents and tools of subsequent layers (e.g., layer 430), of which there could be any number, to execute the tasks. For example, the machine learning insight agent 422 can instruct the text processing tool 432 to perform a text processing task (e.g., transform an artificial intelligence application output into natural language), an image processing tool 434 to perform an image processing task (e.g., generate a natural language summary of an image outputted from artificial intelligence application), a timeseries tool 436 to obtain summarize timeseries data (e.g., timeseries data output from an artificial intelligence application), and an API tool 438 to perform an API call task (e.g., execute an API call to trigger or access an artificial intelligence application).

The information retrieving agent 424 may cooperate with, and/or coordinate, several different agents to perform retrieval tasks. For example, the information retrieving agent 424 may instruct an unstructured data retriever agent 440 to receive unstructured data records, a structured data retriever agent 442 to retrieve structured data records, and a type system retriever agent 444 to obtain one or more data models (or subsets of data models) and/or types from a type system. The type system provides compatibility across different data formats, protocols, operating languages, disparate systems, etc. Types can encapsulate data formats for some or all of the different types or modalities described herein (e.g., multimodal, text, coded, language, statistical, audio, visual, audiovisual, etc.). For example, a data model may include a variety of different types (e.g., in a tree or graph structure), and each of the types may describe data fields, operations, functions, and the like. Each type can represent a different object (e.g., a real-world object, such as a machine or sensor in a factory) or system (e.g., computing cluster, enterprise datastores, file systems), and each type can include a large language model context that provides context for the large language model to design or update a plan. For example, the context may include a natural language summary or description of the type (e.g., a description of the represented object, relationships with other types or objects, associated methods and functions, and the like). Types can be defined in a natural language format for efficient processing by large language models. The type system retriever agent 444 may traverse the data model 454 to retrieve a subset of the data model 454 and/or types of the data model 454. The structured data retriever agent 442 can then use that retrieved information to efficiently retrieve structured data from a structured data source (e.g., a structured data source that is structured or modeled according to the data model 454).

The dashboard agent 426 may be configured to generate one or more visualizations and/or graphical user interfaces, such as dashboards. For example, the dashboard agent 426 may execute tools 452-5 and 452-6 to generate dashboards based on information retrieved by the other agents and/or information output by the other agents (e.g., natural language summaries of associated tool outputs).

The optimizer agent 428 may be configured to execute a variety of different prescriptive analytics functions and mathematical optimizations 452-7 to assist in the calculation of answers for various problems. For example, the large language model 406 may use the optimizer agent 428 to generate plans, determine a set of prescribed tasks, determine whether more information is needed to generate a final result, and the like.

The tool and data model layer 450 is intended to represent a layer of the enterprise generative artificial intelligence system architecture that includes tools 452 and the data model 454. The agents 440-442 can execute the tools 452 to retrieve information from various applications and datastores 482 in the external layer 460 (e.g., external relative to the enterprise generative artificial intelligence system). The tools 452 may include connectors that can connect to systems and datastore that are external to the enterprise generative artificial intelligence system. To reduce the burden of high-volume administrative work, the platform 100 further implements an IP asset intelligence layer. The IP asset intelligence layer allows for request summarization in which the AI summarizes complex request histories, agent notes, and legal statuses into concise, natural-language briefings for administrators. The IP asset intelligence layer further conducts global database search in which the system 100 searches global databases to identify similar prior art, categorizing results by relevance and potential conflict. The IP asset intelligence layer allows for asset reports which are AI-driven analytics visualize portfolio performance, distinguishing between government-required actions and internal milestones.

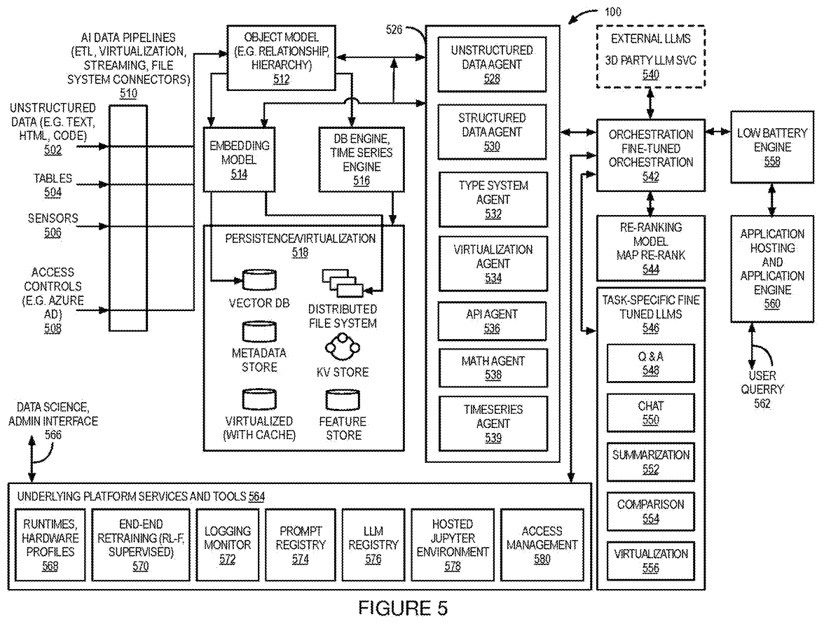

FIG. 5 depicts a diagram of the computer system and method 100 with an architecture of a specialized enterprise generative artificial intelligence system according to some embodiments. In the example of FIG. 5, the specialized enterprise generative artificial intelligence system can ingest disparate data, such as unstructured data 502, structured data (e.g., tables) 504, sensor data 506, and access control information 508. The data may be received via one or more artificial intelligence data pipelines 510. Data may be ingested according to an object model (or, data model) 512, and an embedding model 514 may be used to generate embeddings from the ingested data and persisted and/or virtualized in various datastores 518. The datastores 518 can include vector datastores, metadata datastores, virtualized datastores, distributed file systems, key value datastores, and features stores (e.g., that stores embeddings as features for various models described herein). Database engines and timeseries engines 516 can also be used to persist and/or virtualize data within the datastores 518.

In the example of FIG. 5, the specialized enterprise generative artificial intelligence system includes a variety of different agents 526-539. These are shown by way of example, and various embodiments may include different agents instead of, or in addition to, the agents 526-539. The specialized enterprise generative artificial intelligence system includes an orchestrator 542 with a fine-tuned large language model. The orchestrator 542 and/or agents 526-539 may include and/or access task-specific large language models 548-556, as well as external or third-party large language models 540 in some embodiments. The orchestrator 542 can utilize various underlying platform services tools, such as run-time hardware profiles 568, end-end retraining 560, logging and monitoring 562, prompt registry 574, model registry 576, hosted JUPYTER environment 578, access management controls 560, and/or the like.

In some embodiments, a user query 562 and/or other inputs may be received by an application hosting an application engine 560 which can communicate with a low latency engine 558 to provide the input, or a transformed input, to the orchestrator 542. The orchestrator 542 may utilize the various agents, large language models, and other features to generate an accurate and reliable (e.g., without hallucination) answer to the user query 562. In some embodiments, only a portion of the architecture depicted in FIG. 5 may be deployed in an external environment (e.g., a customer hosted environment or a customer cloud environment). For example, a portion of the architecture may be deployed in an external environment while some or all of the other portions remain in an internal environment (e.g., the internal hosted environment and/or associated cloud environment of the entity providing the enterprise generative artificial intelligence system).

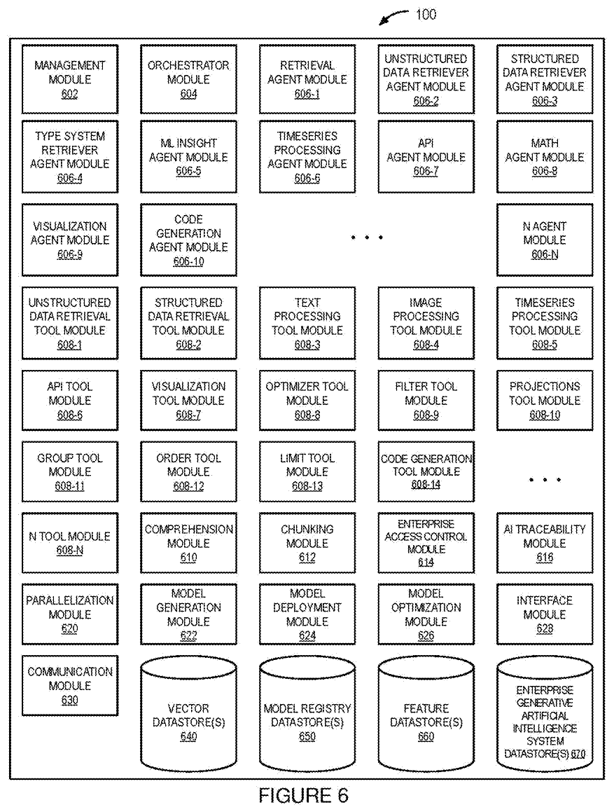

FIG. 6 depicts a diagram of the computer system and method 100 as an exemplary specialized enterprise generative artificial intelligence system according to some embodiments. In the example of FIG. 6, the specialized enterprise generative artificial intelligence computer system and method 100 includes a management module 602, an orchestrator module 604, a retrieval agent module 606-1, an unstructured data retriever agent module, 606-2, a structured data retriever agent module 606-3, a type system retriever agent module 606-4, a machine learning insight module 606-5, a timeseries processing agent 606-6, an API agent module 606-7, a math agent module 606-8, a visualization agent module 606-9, a code generation agent module 606-10, an unstructured data retrieval tool 608-1, an structured data retrieval tool 608-2, a text processing tool module 608-3, an image processing tool module 608-4, a timeseries processing tool module 608-5, an API tool module 608-6, a visualization tool module 608-7, an optimizer tool module 608-8, a filter tool module 608-9, a projections tool module 608-10, a group tool module 608-11, an order tool module 608-12, a limit tool module 608-13, code generation tool module 608-14, a comprehension module 610, a chunking module 612, an enterprise access control module 614, an artificial intelligence traceability module 616, a parallelization module 620, model generation module 622, a model deployment module 624, a model optimization module 626, an interface module 628, a communication module 630, vector datastore(s) 640, model registry datastore(s) 650, feature datastore(s) 660, and enterprise generative artificial intelligence system datastore(s) 660. The management module 602 can function to create, read, update, delete, and govern data objects including IP asset records, workflow instances, document versions, renewal events, financial transactions, and audit logs. The management module 602 can store and manage such data within tenant-isolated datastores and enforce segregation between tenant data at both logical and physical storage layers. It will be appreciated that that datastores can be a single datastore local to the enterprise generative artificial intelligence system 602 and/or multiple datastores remote to the enterprise generative artificial intelligence system 602. In some embodiments, the datastores described herein comprise one or more local and/or remote datastores. The management module 602 can perform operations manually (e.g., by a user interacting with a GUI) and/or automatically (e.g., triggered by one or more of the modules 604-630). Like other modules described herein, some or all the functionality of the management module 602 can be included in and/or cooperate with one or more other modules, systems, and/or datastores.

The orchestrator module 604 functions as a supervisory coordination component that manages task decomposition, agent selection, and result synthesis within the IP management system. Unlike a standard LLM, it:
1. Deconstructs Inputs: It parses complex user requests into structured sub-tasks including draft generation, workflow instantiation, agent assignment, and document routing.
2. Selects Domain Agents: It routes sub-tasks to specialized modules including workflow execution, document governance, renewal verification, financial transaction processing, and generative AI draft generation.
3. Synthesizes Results: It combines structured asset data, workflow states, document metadata, and agent activity logs to generate a unified, policy-compliant output.
   The orchestrator module 604 can function to generate and/or execute one or more orchestrator agents (or, simply, orchestrators). An orchestrator can orchestrate, supervise, and/or otherwise control agents 606. In some implementations, the orchestrator includes one or more large language models. The orchestrator can interpret inputs, select appropriate agents for handling queries and other inputs, and route the interpreted input to the selected agents. The orchestrator can also execute a variety of supervisory functions. For example, the orchestrator may implement stopping conditions to prevent the comprehension module from stalling in an endless loop during an iterative context-based generative artificial intelligence process. The orchestrator may also include one or more other types of models to process (e.g., transform) non-text input. Other models (e.g., other machine learning models, translation models) may also be included in addition to, or instead of, the large language models for some or all of the agents and/or modules described herein. In some embodiments, an orchestrator can process data received from a variety of data sources in different formats that can be processed with natural language processing (NLP) (e.g., with tokenization, stemming, lemmatization, normalization, and the like) with vectorized data and can generate pre-trained transformers that are fine-tuned or re-trained on specific data tailored for an associated data domain or data application (e.g., SaaS applications, legacy enterprise applications, artificial intelligence application). Further processing can include data modeling feature inspection and/or machine learning model simulations to select one or more appropriate analysis channels. Example data objects can include accounts, products, employees, suppliers, opportunities, contracts, locations, digital portals, geolocation manufacturers, supervisory control and data acquisition (SCADA) information, open manufacturing system (OMS) information, inventories, supply chains, bills of materials, transportation services, maintenance logs, and service logs. In some embodiments, the orchestrator module 604 can use a variety of components when needed to inventory or generate objects (e.g., components, functionality, data, and/or the like) using rich and descriptive metadata, to dynamically generate embeddings for developing knowledge across a wide range of data domains (e.g., documents, tabular data, insights derived from artificial intelligence applications, web content, or other data sources). In an example implementation, the orchestrator module 504 can leverage, for example, some or all of the components described herein. Accordingly, for example, the orchestrator module 604 can facilitate storage, transformation, and communication to facilitate processing and embedding data. In some implementations, the orchestrator module can create embeddings for multiple data types across multiple industry verticals and knowledge domains, and even specific enterprise knowledge. For IP-specific tasks, the orchestrator routes notebook entries to agents for structured extraction and draft generation. Knowledge may be modeled explicitly and/or learned by the orchestrator module 604, agents 606, and/or tools 608. In an example, the orchestrator module 604 (and/or chunking module 612, discussed below) generates embeddings that are translated or transformed for compatibility with the comprehension module 610.

In some embodiments, the orchestrator 604 can be configured to make different data domains operate or interface with the components of the enterprise generative artificial intelligence system 602. In one example, the orchestrator module 604 may embedded objects from specific data domains as well as across data domains, applications, data models, analytical by-products artificial intelligence predictions, and knowledge repositories to provide robust search functionality without requiring specialized programming for each different data domain or data source. For example, the orchestrator module 604 can create multiple embeddings for a single object (e.g., an object may be embedded in a domain-specific or application-specific context). In the context of the IP management system, such objects may include IP asset records, workflow instances, renewal events, document versions, and agent activity logs. In some embodiments, the chunking module 612 (discussed below) along with the orchestrator module 604 can curate the data domains for embedding objects of the data domains in the enterprise information systems and/or environments. In some embodiments, the orchestrator 604 can cooperate with the chunking module 612 to provide the embedding functionality described herein.

In some embodiments, the orchestrator module 604 can cause an agent 606 to perform data modeling to translate raw source data formats into target embeddings (e.g., objects, types, and/or the like). Data formats can include structured IP asset records, workflow metadata, document content, government status responses, payment confirmations, and related tenant-specific data representations. In an example implementation, the orchestrator module 604 employs a type system of a model-driven architecture to perform data modeling to translate raw source data formats into target types. A knowledge base of the specialized enterprise generative artificial intelligence system and generative artificial intelligence models can create the ability to integrate or combine insights from different artificial intelligence applications. As discussed elsewhere herein, the enterprise generative artificial intelligence computer system and method 100 can handle machine-readable inputs (e.g., compiled code, structured data, and/or other types of formats that can be processed by a computer) in addition to human-readable inputs. Inputs can also include complex inputs, such as inputs including “and,” “or”, inputs that include different types of information to satisfy the input (e.g., text documents, database tables, and artificial intelligence insights). The orchestrator 604 may break up these complex inputs (e.g., by using a large language model) to be handled by multiple agents 606 (e.g., in parallel). As discussed above, the orchestrator module 604 can function to execute and/or otherwise process various supervisory functions. In some implementations, the orchestrator module 604 may enforce conditions (e.g., stopping conditions, resource allocation, prioritization, and/or the like). For example, a stopping condition may indicate a maximum number of iterations (or, hops) that can be performed before the iterative process terminates. The stopping condition, and/or other features managed by the orchestrator module 604, may be included in large language model prompts and/or in the large language models of the orchestrator and/or comprehension module 610, discussed below. In some embodiments, the stopping conditions can ensure that the enterprise generative artificial intelligence computing system and method 100 will not get stuck in an endless loop. Additionally, stopping conditions may enforce policy constraints to prevent AI-generated outputs from being transmitted into active workflows without required tenant authorization or role-based validation. This feature can also allow the enterprise generative artificial intelligence computing system and method 100 the flexibility of having a different number of iterations for different inputs (e.g., as opposed to having a fixed number of hops). In another example, the orchestrator module 604 can perform resource allocation such as virtualization or load balancing based on computing conditions. In some implementations, the orchestrator module 604 and/or agents 606 include models that can convert (or, transform) an image, database table, and/or other non-text input, into text format (e.g., natural language).

In some embodiments, the orchestrator module 604 can function to cooperate with agents 606 (e.g., retrieval agent module 606-1, unstructured data retriever agent module 606-2, structured data retriever agent module 606-3) to iteratively and non-iteratively process inputs to determine output results or answers, determine context and rationales for informing subsequent iterations, and determine whether large language models (e.g., of the orchestrator 604 and/or comprehension module 610) require additional information to determine answers. For example, the orchestrator module 604 may receive a query and instruct agent 606-1 to retrieve associated information. The retrieval agent module 606-1 may then select unstructured data retriever agent module 606-2 and/or structured data retriever agent module 606-3 depending on whether the orchestrator module 604 wants to retrieve structured or unstructured data records. The appropriate agents 606 can the select the corresponding tools and provide the tool output to the orchestrator module 604 and/or comprehension module 610 for determining a final result. The orchestrator 604 may also select and swap models as needed. For example, the orchestrator 604 may change out models (e.g., data models, large language models, machine learning models) of the enterprise generative artificial intelligence system 602 at or during run-time in addition to before or after run-time. For example, the orchestrator 604, agents 606, and comprehension module 610 may use particular sets of machine learning models for one domain and other models for different domains. The orchestrator 604 may select and use the appropriate models for a given domain and/or input.

In some embodiments, the orchestrator 604 may combine (e.g., stitch) outputs/results from various agents to create a unified output. For example, one or more of the agent modules 606 may obtain/output a document (or segment(s) thereof) or related information (e.g., text summary or translation), another agent module 606 may obtain/output a database table, and the like. The orchestrator 604 may then apply deterministic workflow logic and, where appropriate, machine learning models to combine the outputs/results into a unified output.

In some implementations, the orchestrator 604 pre-processes inputs (e.g., initial inputs) prior to the input being sent to one or more agents 606 for processing. For example, the orchestrator 604 may transform a first portion of an input into a structured query language (SQL) query and send that to an unstructured data retriever agent module 606-2 agent, transform a second portion of the input into an API call and send that to an API agent module 606-7, and the like. In another example, such transformation functionality may be performed by the agents 606 instead of, or in addition to, the orchestrator 604.

The orchestrator module 604 can function to process, extract and/or transform different types of data (e.g., text, database tables, images, video, code, and/or the like). For example, the orchestrator module 604 may take in a database table as input and transform it into natural language describing the database table which can then be provided to the comprehension module 610, which can then process that transformed input to “answer,” or otherwise satisfy a query. In some embodiments, a large language model may be used to process text, while another model may be used to convert (or, transform) an image, database table, and/or other non-text input, into text format (e.g., natural language).

It will be appreciated that, in some embodiments, the orchestrator module 604 can include some or all of the functionality of the comprehension module 610. For example, the comprehension module 610 may be a component of the orchestrator module 604. Similarly, in some embodiments, the comprehension module 610 may include some or all of the functionality of the orchestrator module 604. In the example of FIG. 6, the agent modules 606 include a variety of different example agent modules 606-1 to 606-N. It will be appreciated that these are shown by way of example, and various embodiments may include different agents instead of, or in addition to, the agents 606-1 to 606-N. In some embodiments, each of the agents 606 comprises hardware and/or software, and include one or more large language models, one or more other machine learning models, and/or functions, to provide reasoning functionality to accomplish a prescribed set of tasks. It will be appreciated that reference to an agent module may refer to the agent itself and/or the component that generates and/or executes the agent. In some embodiments, the orchestrator is a type of agent and may be referred to as an orchestrator agent. Accordingly, reference to orchestrator may refer to the orchestrator itself and/or the component that generates and/or executes the orchestrator. In some embodiments, agents 606 use models to determine a sequence of choices. The determined decision sequence can include comparing choices, summarizing multiple choices, and/or analyzing multiple choices to generate context information about the choices. The agents 606 may also check conflicts or similarities between choices. In various embodiments, some or all the agents 606 can process data having disparate data types and/or data formats. For example, the agent modules 606 may receive a database table or an image as input (e.g., received from a tool 608) and translate the table or image into natural language describing the table or image which can then be output for processing by other modules, models, and/or systems (e.g., the orchestrator module 604 and/or comprehension module 610). In one example, a large language model may be used to process text, while another model may be used to convert (or, transform) an image, database table, and/or other non-text input, into text format (e.g., natural language). The retrieval agent module 606-1 can function to retrieve structured and unstructured data records. In some embodiments, the retrieval agent module 606-1 can coordinate/instruct the unstructured data retriever agent module 606-2 to retrieve unstructured data records and coordinate/instruct the structured data retriever agent module 606-3 and the type system retriever agent 606-4 to retrieve structured data records. For example, the retrieval agent module 606-1 may cooperate with other agents 606 and tools 608 to generate SQL queries to query an SQL database. The unstructured data retriever agent module 606-2 can function to retrieve unstructured data records (e.g., from an unstructured datastore) and/or passages (or, segments) of those data records. Unstructured data records may include, for example, text data that is stored on a file system in a format such as PDF, DOCX, .MD, HTML, TXT, PPTX, and the like. In the IP management system, such unstructured data may include, and not limited to, lab notebook entries, draft patent specifications, trademark filings, office action responses, licensing agreements, and trade secret documentation.

In some embodiments, the agent 606-2 can use embeddings (e.g., vectors stored in vector store 640) when retrieving information. For example, the agent 606-2 can use a similarity evaluation or search on the vector datastore 740 to find relevant data records based on k-nearest neighbor, where embeddings that are closer to each other are more likely relevant. In some embodiments, the unstructured data retriever agent module 506-2implements a Read-Extract-Answer (REA) data retrieval process and/or a Read-Answer (RA) data retrieval process. More specifically, REA and RA can be appropriate when the computer system and needs 100 needs to process large amounts of data. For example, a query may identify many different data records and/or passages (e.g., hundreds or thousands of data records and passages). For simplicity, reference to data records may include data records and/or passages.

More specifically, the unstructured data retriever agent module 606-2 can determine whether each data record is relevant to answer the query and filter out the data records that are not relevant. For example, the agent 606-2 can calculate and assign relevance scores (e.g., using a machine learning relevance model) for each of the retrieved data records. The relevance score can be relative to the other retrieved data records. For example, the least relevant data record may be assigned a minimum value (e.g., 0) and the most relevant data record may be assigned a maximum value (e.g., 100). The unstructured data retriever agent module 606-2 may filter out documents that are relevant (or the documents that are not relevant). For example, the unstructured data retriever agent module 606-2 may filter out data records that have a relevance score below a configurable threshold value (e.g., 50). In some embodiments, the number of data records that the unstructured data retriever agent module 606-2 can retrieve for a particular input or query can be user or system defined, and also may be configurable. For example, a system may define that a maximum of 50 data records can be returned.

In some embodiments, a large language model (e.g., of the unstructured data retriever agent module 606-2) can identify key points of the relevant documents and passages, and then provide the key points to a large language model (e.g., a large language model of the orchestrator 604). The large language model can provide a summary which can be used to generate the query answer (e.g., the summary can be the query answer). This can, for example, allow the computer system and method 100 to look at a wide diversity of concepts and documents (e.g., as opposed to an iterative process). In some embodiments, if the number of documents or passages is below a threshold value, the unstructured data retriever agent module 606-2 can skip the “extract” step (e.g., summarizing key points), and provide the passages directly to the large language model. This can be referred to as the RA process.

The structured data retriever agent module 606-3 can function to retrieve structured data records, and/or passages (or, segments) thereof, from various structured datastores. For example, structured data records can include tabular data persisted in a relational database, key value store, or external database and modeled or accessed with entity types (or, simply, types). Such structured records may include IP asset identifiers, jurisdiction codes, filing dates, renewal deadlines, prosecution statuses, assigned agents, workflow identifiers, and transaction references. Structured data records can include data records that are structured according to one or more data models (e.g., complex data models) and/or data records that can be retrieved based on the one or more data models. For example, structured IP asset records may include jurisdiction identifiers, filing dates, renewal deadlines, current prosecution status, assigned agents, and payment transaction identifiers. Structured data records can include data records stored in a structured datastore (e.g., a datastore structured according to one or more data models). In a specific implementations, data models may include a graph structure of objects or types, and the agents 606 and/or tools 608 can traverse the graph in different paths to identify relevant types of the data model (e.g., depending on the query and a plan to answer the query provided by the orchestrator module 604) and can combine multiple tables with complex joins (e.g., as opposed to simply passing a single data from and performing operations on that single table). The paths may be stored in a datastore (e.g., a vector datastore 640) for efficient retrieval.

In some embodiments, the structured data retriever agent module 606-3 can use a variety of different tools to retrieve structured data (e.g., structured data retrieval tool 608-2, filter tool 608-9, projections tool 608-10, group tool 608-11, order tool 608-12, limit tool 608-13, and the like). In some embodiments, once the structured data retriever agent module 606-3 has traversed the data model and retrieved the relevant type(s) and/or subsets of the data model, the structured data retriever agent module 606-3 can then use that information, along with the agent and/or tool outputs, to construct a structured query specification which it can execute against one or more structured datastores to retrieve the structured data records. The type system retriever agent module 606-4 can function to retrieve types, data models, and/or subsets of data models. For example, a data model may include a variety of different types, and each of the types may describe data fields, operations, and functions. Each type can represent a different object (e.g., a real-word object, such as a machine or sensor in a factor), and each type can include a large language model context that provides context for a large language model. Types can be defined in a natural language format for efficient processing by large language models.

The visualization agent module 606-9 can function to generate one or more visualizations and/or graphical user interfaces, such as dashboards, charts, and the like. For example, the visualization agent module 606-9 may execute visualization tool module 608-7 to generate dashboards based on information retrieved by the other agents and/or information output by the other agents (e.g., natural language summaries of associated tool outputs). The visualization agent module 606-9 may also function to generate summaries (e.g., natural language summaries) of visual elements, such as charts, tables, images, and the like.

The code generation agent module 606-10 can function to instruct the code generation tool module 608-14 to generate source code, machine code, and/or other computer code. For example, the code generation agent module 606-10 may be configured to determine what code is needed (e.g., to satisfy a query, create an application, and the like) and instruct the tool 608-14 to generate that code in a particular language or format.

In some embodiments, the tools 608 are specific functions that agents (e.g., agents 606, orchestrator module 604) can access or execute while attempting to accomplish prescribed task(s) (e.g., of a set of prescribed tasks of a plan determined by the orchestrator module 604). Tools 608 can include software and/or hardware. Tools 608 may also include one or more machine learning models, but they may also include functions without any machine learning model. Execution of such tools within the IP management system is constrained by tenant isolation policies and document-level access controls enforced by the security and trade secret vault modules. In some embodiments, tools 608 do not include large language models, although in other embodiments tools may include large language models. In some embodiments, some or all of the agents 606 and/or tools 608 can be manually configured (e.g., by a user). Agents 606 and tools 608 may also normalize data (e.g., to a common data format) before outputting the data. The unstructured data retrieval tool 608-1 can function to retrieve unstructured data records from an unstructured data store. In some embodiments, the agent 606-2 can use embeddings (e.g., vectors stored in vector store 740) when retrieving information. For example, the agent 606-2 can use a similarity evaluation or search to find relevant data records based on k-nearest neighbor, where embeddings that are closer to each other are more likely relevant. The structured data retrieval tool 608-2 can function to access and retrieve structured data records from a structured datastore (e.g., structured or modeled according to a data model). The structured data retrieval tool 608-2 may be executed by the structured data retriever agent module 606-3). The text processing tool module 608-3 can function to retrieve and/or transform text (e.g., from unstructured data records) and perform other text processing tasks (e.g., transform a text-based output of artificial intelligence application into natural language). The image processing tool module 608-4 can function to perform an image processing task (e.g., generate a natural language summary of an image). The timeseries processing tool module 608-5 can function to obtain and/or process timeseries data (e.g., output from artificial intelligence applications, sensors, and the like). For example, the timeseries processing tool module 608-3 may be executed one or more of the agents 606 to obtain and process timeseries data. The API tool module 608-6 can function to perform an API call task (e.g., execute an API call to trigger or access an artificial intelligence application). For example, different agents 606 may use the API tool module 606-8 whenever the agent needs to access or trigger another application. The visualization tool module 608-7 can function to generate one or more visualizations and/or graphical user interfaces, such as dashboards. For example, the visualization tool module 508-7 may generate dashboards based on information retrieved by the other agents and/or information output by the other agents (e.g., natural language summaries of associated tool outputs). The filter tool module 608-9 can function to filter data records, types, and/or the like. Execution of filtering, grouping, projection, and ordering operations is constrained by tenant isolation policies and document-level access controls enforced by the security module 1700 and trade secret vault subsystem 2000. For example, the filter tool module 608-9 may filter projections (e.g., fields) identified by the projections tool module 608-10 as part of a structured data retrieval process. In various embodiments, tools 608 can execute in parallel or otherwise. In some embodiments, the filter tool module 608-9 can identify implicit filters based on a query or other input, and those identified implicit filters can be used as part of a structed data retrieval process. The filter tool module 608-9 may also identify contextual datetime filters. The filter tool module 608-9 may determine yesterday's date while accounting for time zone and other relevant data to generate an accurate filter. In some embodiments, the filter tool module 608-9 can validate identified filters prior to the filters being used (e.g., as part a structured data retrieval process). The projections tool module 608-10 can function to identify and select fields (e.g., type fields, object fields) that are relevant to determine an answer to a query or other input. The group tool module 608-11 can function to group data (e.g., types, tool outputs, and the like) which can then be used to generate structured query requests (e.g., by the structured data retriever agent module 606-3 and/or structured data retrieval tool module 608-2).

The order tool module 608-12 can function to order data (e.g., types, tool outputs, and the like) which can then be used to generate structured query requests (e.g., by the structured data retriever agent module 606-3 and/or structured data retrieval tool module 658-2). The limit tool module 608-13 can function to limit the output of a structured data retrieval process. For example, it may limit the number of retrieved data records, types, groups, filters, and or the like. The code generation tool module 608-14 can function to generate source code, machine code, and/or other computer code. For example, the code generation tool module 608-14 may be configured to generate and/or execute SQL queries, JAVA code, and/the like. The code generation tool module 608-14 may be used to facilities query generation for agents, other tools, large language models, and the like. The code generation tool module 608-15, in some embodiments, may be configured to generate source code for an application or create an application. The comprehension module 610 can function to process inputs to determine results (e.g., “answers”), determine rationales for results, and determine whether the comprehension module 610 needs more information to determine results. The comprehension module 610 may output information (e.g., results or additional queries) in a natural language format or machine language format. In some implementations, features of one or more models of the comprehension module define conditions or functions that determine if more information is needed to satisfy the initial input or if there is enough information to satisfy the initial input. In some embodiments, the comprehension module 610 includes one or more large language models. The large language models may be configured to generate and process context, as well as the other information described herein. The comprehension module 610 may also include other language models that pre-process inputs (e.g., a user query) prior to inputs being provided to the agents for handling. The comprehension module 610 may also include one or more large language models that process outputs from other models and modules (e.g., models of the agents 606). The comprehension module 610 may also include another large language model for processing answers from one large language model into a format more consistent with a final answer that can be transmitted to various users and/or systems (e.g., users or systems that provided the initial query or other intended recipient of the answer). For example, the comprehension module 610 may format answers according to various viewpoints. Viewpoints can be based on a type of user (e.g., human or machine), user roles (e.g., e.g., data scientist, engineer, director, and the like), access permissions, and the like. Accordingly, viewpoints enable the comprehension module 610 to generate and provide an answer specifically targeted for the recipient. The comprehension module 610 may also notify users and systems if it cannot find an answer (e.g., as opposed to presenting an answer that is likely faulty or biased).

In some implementations, features of one or more large language models of the comprehension module 610 define conditions or functions that determine if more information is needed to satisfy the initial input or if there is enough information to satisfy the initial input. The large language models of the comprehension module 610 may also define stopping conditions that indicate a stopping threshold condition indicating a maximum number of iterations that may be performed before the iterative process is terminated. In some embodiments, the comprehension module 610 can generate and store rationales and contexts (e.g., in datastore 670). The rationale may be the reasoning used by the comprehension module 610 to determine an output (e.g., natural language output, an indication that it needs more information, an indication that it can satisfy the initial input). The comprehension module 610 may generate context based on the rationale. In some implementations, the context comprises a concatenation and/or annotation of one or more segments of data records, and/or embeddings associated therewith, along with a mapping of the concatenations and/or annotations. For example, the mapping may indicate relationships between different segments, a weighted or relative value associated with the different segments, and/or the like. The rational and/or context may be included in the prompts that are provided to the large language models.

In some embodiments, the comprehension module 610 includes a query and rational generator that generates queries or other inputs for models (e.g., large language models, other machine learning models) and/or generates and stores the rationales and contexts (e.g., in the datastore 660). The query and rational generator can function to process, extract and/or transform different types of data (e.g., text, database tables, images, video, code, and/or the like). For example, the query and rational generator may take in a database table as input and transform it into natural language describing the database table which can then be provided to the one or more other models (e.g., large language models) of the comprehension module 610, which can then process that transformed input to “answer,” or otherwise satisfy a query. In some implementations, the query and rational generator includes models that can convert (or, transform) an image, database table, and/or other non-text input, into text format (e.g., natural language). It will be appreciated that although queries are used in various examples throughout, other types of inputs (e.g., instruction sets) may be processed in the same or similar manner as described with respect to queries. In some embodiments, the comprehension module 610 can use different models for different domains. Accordingly, the comprehension module 610 can use particular models (e.g., data models and/or large language models) for a particular domain (e.g., a data model describing properties and relationships of aerospace objects and a large language model trained on aerospace-specific datasets) and use another data model and/or large language model for another domain (e.g., data model describing properties and relationships of defense-specific objects and a large language model trained on defense-specific datasets), and so forth. In some embodiments, the orchestrator module 604 includes some or all of the functionality and/or structure of the comprehension module 610 and/or 606, described further below. Similarly, in some embodiments, the comprehension module 610 may include some or all of the functionality and/or structure of the orchestrator module 604.

In some embodiments, the comprehension module 610 can function to generate large language model prompts (or, simply, prompts) and prompt templates. For example, the comprehension module 610 may generate a prompt template for processing an initial input, a prompt template for processing iterative inputs (i.e., inputs received during the iteration process after the initial input is processed), and another prompt template for the output result phase (i.e., when the comprehension module 610 has determined that it has enough information and/or a stopping condition is satisfied). The comprehension module 610 may modify the appropriate prompt template depending on a phase of the iterative process. For example, prompt templates can be modified to generate prompts that include rationales and contexts, which can inform subsequent iterations.

The chunking module 612 can function to process (e.g., chunk) a corpus of data records (e.g., of one or more enterprise systems) for handling by the enterprise generative artificial intelligence system 602. Data records, as used herein, may include any type of data record that may be stored in a datastore, such as unstructured data records and structured data records. For example, data records can include documents (e.g., PDF, text, html, markdown source code), database tables, information generated by application (e.g., artificial intelligence application insights), images, audiovisual files, executables, data records structured according to a data model and/or type system, and the like. More specifically, the chunking module 612 can pre-process and chunk the data records. The chunking process can partition data records and insert or append a respective header for each chunk. The header may include, for example, one or more attributes describing the chunk (e.g., type of data records, size of chunk, etc.). Chunks may be referred to as segments herein. Segments may include, for example, the header along with a passage of a text document, a portion of database table, and so forth. For simplicity, reference to a passage may include a segment and/or the content (e.g., text) of a segment. Segments can be stored in a segment datastore (e.g., vector store 740). A data record can be chunked into a tree structure where each leaf corresponds to a segment. Chunking can be rule-based.

In some implementations, pre-processing includes generating contextual information for data records and/or segments. The contextual information may improve security, as well as accuracy and reliability of associated retrieval operations. In one example, contextual information comprises contextual metadata. The contextual information can include references between segments and/or data records. For example, the references may indicate relationships that can be used (e.g., traversed) when performing similarity evaluations or other aspects of retrieval operations (e.g., by one or more of the agents 606). Contextual information may also include information that can assist a large language model in generating a plan and/or answers. For example, the chunking module 612 may generate contextual information for structured data chunks (or passages) that include natural language descriptions of the data records, locations of related data records, and the like.

The contextual information may include access controls. In some implementations, contextual information provides user-based access controls. More specifically, the contextual information can indicate user roles that may access a corresponding segment and/or data record, and/or user roles that may not access a corresponding segment and/or data record. The contextual information may be stored in headers of the data records and/or data record segments. In some embodiments, the chunking module 612 can generate embeddings based on both structured and unstructured data records and/or segments. The chunking module 612 may include a deep learning model that can convert and/or transform data records into a vector representation, where the vectors for semantically similar data records (e.g., the content of the data records) are close together in the vector space. This can facilitate retrieval operations by the agents 606 and tools 608. In some embodiments, the chunking module 612 can generate embeddings using one or more embeddings models. The embeddings may include a numerical representation for unstructured and/or structured data records that captures the semantic or contextual meaning of the data records. For example, the embeddings may be represented by one or more vectors. The embeddings may be used when retrieving data records and performing similarity evaluations or other aspects of retrieval operations. The embeddings may be stored in an embeddings index (e.g., vector datastore 640). In some embodiments, the vector store 640 is a type of database that is specifically optimized for storing embeddings and retrieving embeddings using a similarity heuristic (e.g., an approximate nearest neighbor (ANN) algorithm) that can be implemented by the agents 606 and/or tools 608.

In some implementations, the chunking module 612 generates enriched embeddings. For example, the chunking module 612 may generate enriched embeddings based on the contextual information, data records, and/or data record segments. An enriched embedding may comprise a vector value based on an embedding vector and the contextual information. In some embodiments, an enriched embedding comprises the embedding vector value along with the contextual metadata including the contextual information. Enriched embeddings may be indexed in an enriched embeddings datastore (e.g., a vector datastore 640). The agents 606 and/or tools 608 may retrieve unstructured and/or structured data records based on enriched embeddings.

In some embodiments, the chunking module 612 may perform some or all of the functionality described herein periodically (e.g., in batches), on-demand, and/or in real time. For example, the chunking module 612 may periodically trigger, on-demand trigger, manually trigger, and/or automatically trigger, the chunking described herein. In some implementations, subsequent chunking operations may only incorporate changes relative to previous chunking operations (e.g., the “delta”).

In some embodiments, the chunking module 612 may generate contextual information for data records and/or segments. The contextual information may be represented by contextual metadata that provides access control (e.g., role-based access control (RBAC)) to associated data records and/or segments. The contextual information may maintain references between data records and/or data records segments. The chunking module 612 may insert and/or append contextual information in segment headers. The chunking module 612 may generate contextual information before, after, or at the same time as the associated embeddings are generated. For example, embeddings may be created using context information, or embeddings may be enriched with contextual information. The contextual information may be used by the chunking module 612 to map relationships between data records and/or segments of one or more enterprises or enterprise systems and store those relationships in a data model and/or datastore (e.g., datastore 760). As discussed elsewhere herein, the chunking module 612 can generate embeddings and/or enriched embeddings. In one example, the chunking module 612 implements a word2vec algorithm. In some implementations, the chunking module 612 utilizes models trained on domain-specific (or, industry-specific) datasets.

The enterprise access control module 614 can function to provide enterprise access controls (e.g., layers and/or protocols) for the enterprise generative artificial intelligence system 402, associated systems (e.g., enterprise systems), and/or environments (e.g., enterprise information environments). The enterprise access control module 614 can provide functionality for enforcement of access control policies with respect to generating results (e.g., preventing the orchestrator module 604 and/or comprehension module 610 from generating results that include sensitive information) and/or filtering results that have already been generated prior to providing a final result.

In some implementations, the enterprise access control module 614 may evaluate (e.g., using access control lists) whether a user is authorized to access all or only a portion of a result (e.g., answer). For example, a user can provide a query associated with a first department or sub-unit of an organization. Members of that department or sub-unit may be restricted from accessing certain pieces of data, types of data, data models, or other aspects of a data domain in which a search is to be performed. Where the initial results include data for which access by the user is restricted, the enterprise access control module 614 can determine how such restricted data is to be handled, such as to omit the restricted data entirely, omit the restricted data but indicate the results include data for which access by the user is restricted, or provide information related to all of the initial results. In the example where restricted data is omitted entirely, a final set of results may be returned for presentation to the user, where the final set of results does not inform the user that a portion of the initial results have been omitted. In the example where the restricted data is omitted but an indication of the presence of the restricted data is provided to the user, the final results may include only those results for which the user is authorized for access, but may include information indicating there were X number of initial results but only Y results are outputted, where Y<X. In the third example described above, all of the results may be outputted to the user, including results for which access is restricted by the user. Additionally, or alternatively, the enterprise access control module 614 may communicate with one or more other modules to obtain information that may be used to enforce access permissions/restrictions in connection with performing retrieval operations instead of for controlling presentation of the results to the user. For example, enterprise access control module 614 may restrict the data sources to which retrieval operations are applied, such as to not apply a retrieval operation to portions of the data sources for which user access is denied and apply the retrieval operations to portions of the data sources for which user access is permitted. It is noted that the exemplary techniques described above for enforcing access restrictions have been provided for purposes of illustration, rather than by way of limitation and it should be understood that modules operating in accordance with embodiments of the present disclosure may implement other techniques to present results via an interface based on access restrictions.

In some embodiments, to facilitate the enforcement of access restrictions in connection with searches performed by the enterprise generative artificial intelligence computing system and method100, the enterprise access control module 614 may store information associated with access restrictions or permissions for each user. To retrieve the relevant restriction data for a user, the enterprise access control module 614 may receive information identifying the user in connection with the input or upon the user logging into system on which the enterprise access control module 614 is executing. The enterprise access control module 614 may use the information identifying the user to retrieve appropriate restriction data for supporting enforcement of access restrictions in connection with an enterprise search. In some embodiments, the enterprise access control module 614 can include credential management functionality of a model driven architecture in which the enterprise generative artificial intelligence system 402 is deployed or may be a remote credential management system communicatively coupled to the enterprise generative artificial intelligence system 402 via a network.

The artificial intelligence traceability module 616 can function to provide traceability and/or explainability of answers generated by the enterprise generative artificial intelligence computing system and method 100. For example, the artificial intelligence traceability module 616 can indicate portions of data records used to generate the answers and their respect data sources. The artificial intelligence traceability module 616 can also function to corroborate large language model outputs. For example, the artificial intelligence traceability module 616 can provide sources citations automatically and/or on-demand to corroborate or validate large language model outputs. The artificial intelligence traceability module 616 may also determine a compatibility of the different sources (e.g., data records, passages) that were used to generate a large language model output. For example, the artificial intelligence traceability module 616 may identify data records that contradict each other (e.g., one of the data records indicate that John Doe is an employee at Acme corporation and another data record indicates that John Doe works at a different company) and provide a notification that the output was generated based on contradictory on conflicting information.

The parallelization module 620 can function to control the parallelization of the various systems, modules, agents, models, and processes described herein. For example, the parallelization module 620 may spawn parallel executions of different agents and/or orchestrators. The parallelization module 620 may be controlled by the orchestrator module 604. The model generation module 622 can function to obtain, generate, and/or modify some or all of the different types of models described herein (e.g., machine learning models, large language models, data models). In some implementations, the model generation module 622 can use a variety of machine learning techniques or algorithms to generate models. As used herein, artificial intelligence and/or machine learning can include Bayesian algorithms and/or models, deep learning algorithms and/or models (e.g., artificial neural networks, convolutional neural networks), gap analysis algorithms and/or models, supervised learning techniques and/or models, unsupervised learning algorithms and/or models, semi-supervised learning techniques and/or models random forest algorithms and/or models, similarity learning and/or distance algorithms, generative artificial intelligence algorithms and models, clustering algorithms and/or models, transformer-based algorithms and/or models, neural network transformer-based machine learning algorithms and/or models, reinforcement learning algorithms and/or models, and/or the like. The algorithms may be used to generate the corresponding models. For example, the algorithms may be executed on datasets (e.g., domain-specific data sets, enterprise datasets) to generate and/or output the corresponding models.

In some embodiments, a large language model is a deep learning model (e.g., generated by a deep learning algorithm) that can recognize, summarize, translate, predict, and/or generate text and other content based on knowledge gained from massive datasets. Large language models may comprise transformer-based models. Large language models can include Google's BERT, OpenAI's GPT-3, and Microsoft's Transformer. Large language models can process vast amounts of data, leading to improved accuracy in prediction and classification tasks. The large language models can use this information to learn patterns and relationships, which can help them make improved predictions and groupings relative to other machine learning models. Large language models can include artificial neural network transformers that are pre-trained using supervised and/or semi-supervised learning techniques. In some embodiments, large language models comprise deep learning models specialized in text generation. Large language models, in some embodiments, may be characterized by a significant number of parameters (e.g., in the tens or hundreds of billions of parameters) and the large corpuses of text used to train them.

Although the systems and processes described herein use large language models, it will be appreciated that other embodiments may use different types of machine learning models instead of, or in addition to, large language models. For example, an orchestrator 604 may use deep learning models specifically designed to receive non-natural language inputs (e.g., images, video, audio) and provide natural language outputs (e.g., summaries) and/or other types of output (e.g., a video summary).

The model deployment module 624 can function to deploy some or all of the different types of models described herein. In some implementations, the model deployment module 624 can deploy models before or after a deployment of enterprise generative artificial intelligence system. For example, the model deployment module 524 may cooperate with the model optimization module 626 to swap or other change large language models of an enterprise generative artificial intelligence system. In some implementations, a model registry 650 can store various models (e.g., machine learning models, large language models, data models) and/or model configurations. The models may be trained on generic datasets and/or domain-specific datasets. For example, the model registry may store different configurations of various large language models (e.g., which can be deployed or swapped in an enterprise generative artificial intelligence system 402). In some embodiments, each of the models may be associated with an embedding value, or enriched embedding value, to facilitate retrieval operations (e.g., in the same or similar manner as data records retrievals).

The model optimization module 626 can function to enable tuning and learning by the modules (e.g., the comprehension module 612) and/or the models (e.g., machine learning models, large language models) described herein. For example, the model optimization module 626 may tune the comprehension module 610 and/or orchestrator module 604 (and/or models thereof) based on tracking user interactions within systems, capturing explicit feedback (e.g., through a training user interface), implicit feedback, and/or the like. In some example implementations, the model optimization module 626 can use reinforcement learning to accelerate knowledge base bootstrapping. Reinforcement learning can be used for explicit bootstrapping of various systems (e.g., the enterprise generative artificial intelligence computing system and method 100) with instrumentation of time spent, results clicked on, and/or the like. Example aspects of the model optimization module 626 include an innovative learning framework that can bootstrap models for different enterprise environments.

In some embodiments, the model optimization module 626 can retrain models (e.g., transformer-based natural language machine learning models) periodically, on-demand, and/or in real-time. In some example implementations, corresponding candidate model (e.g., candidate transformer-based natural language machine learning models) can be trained based on the user selections and the model optimization module 626 can replace some or all of the models with one or more candidate models that have been trained on the received user selections. It is noted that the described functionality has been provided by way of non-limiting example and other techniques may be used to generate queries and commands. For example, in additional or alternative implementations using multimodal or generative pre-trained transformers, which is an autoregressive language model that uses deep learning to produce human-like text, may be used to generate a query from the search input (i.e., without use of a seed bank). Input is subjected to embedding and vectorization, with a large language model is used for query generation the entity matched search input may be provided to the generative multimodal or large language model algorithm to generate the query. In such an implementation, a generative multimodal algorithm may be provided with contextual information, such as a schema of metadata defining table headers, field descriptions, and joining keys, which may be used to retrieve the search results. For example, the schema may be used to translate the entity matched search input into a query (e.g., an SQL query).

The communication module 630 can function to send requests, transmit and receive communications, and/or otherwise provide communication with one or more of the systems, modules, engines, layers, devices, datastores, and/or other components described herein. In a specific implementation, the communication module 630 may function to encrypt and decrypt communications. The communication module 630 may function to send requests to and receive data from one or more systems through a network or a portion of a network (e.g., communication network 218). In a specific implementation, the communication module 630 may send requests and receive data through a connection, all or a portion of which can be a wireless connection. The communication module 630 may request and receive messages, and/or other communications from associated systems, modules, layers, and/or the like. Communications may be stored in the enterprise generative artificial intelligence system datastore 660.

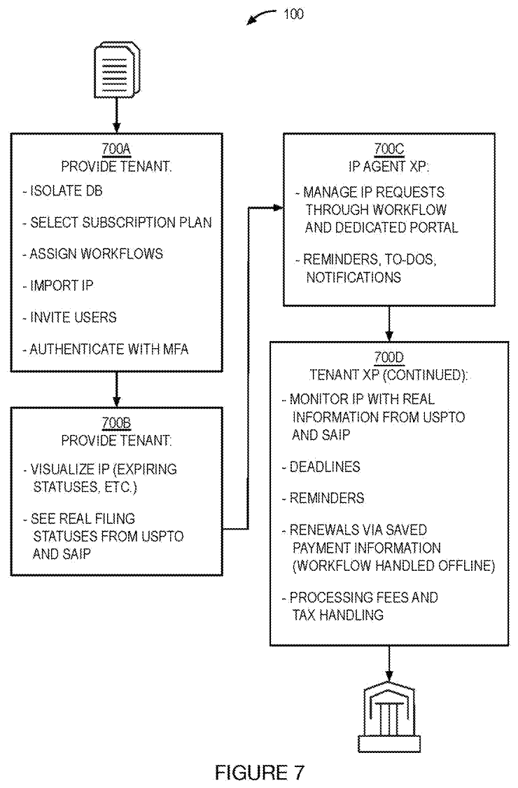

FIG. 7 discloses a method of using the computing system and method 100. In a first step 700A which is a provide tenant step, the following substeps shall be implemented. The tenant (or user) interacts with the computer system and method 100 to isolate the database, select a subscription plan, assigns workflows, import the intellectual property, invite users, and authenticate with multi-factor authentication. The system 100 allows the user to visualize their IP (e.g., statuses, expirations), and see real filing statuses from patent offices (e.g., USPTO, SAIP) 700B. An IP agent manages IP requests through workflow and a dedicated portal 700C. The IP agent is also capable of providing reminders, to-dos, and notifications to the user. In 700D, the system 100 allows the tenant to monitor IP with real information from government offices (e.g, patent offices, trademark offices, copyright offices, etc). In addition, the system 100 can provide deadlines, reminders, renewals via saved payment information (e.g., workflow handled offline), processing fees and tax handling.

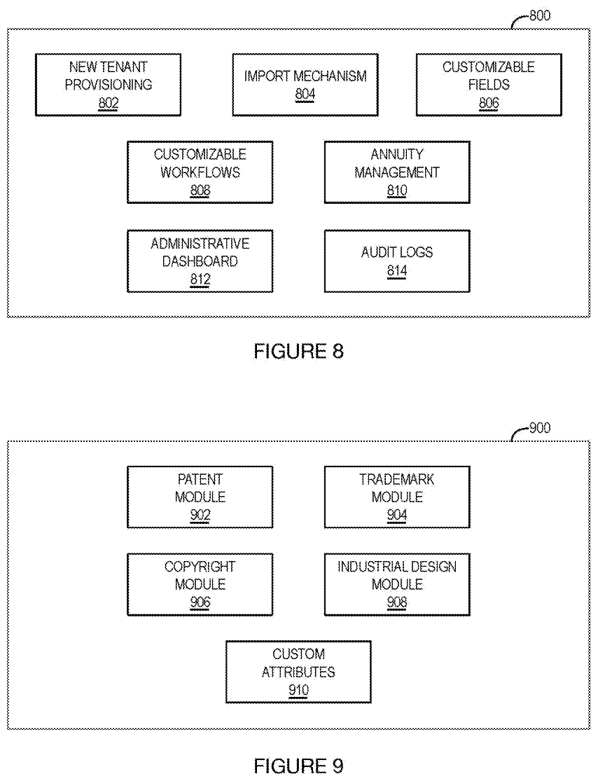

FIGS. 8-19 detail a series of panels having modules which are part of the computer system and method 100.

FIG. 8 discloses an administrative panel 800 configured as a system-level control interface for provisioning tenant environments, configuring IP services, enforcing access policies, and governing platform-wide operations. It features a new tenant (or user) provision module 802 with the ability to create, edit, and delete tenants that have isolated data environments. An import mechanism module 804 with the ability to import IP data from comma-separated values (CSV) files & other structured formats such as Excel for specific tenants, including country, expiration date, logo, notes, and other relevant columns for specific pieces of IP (including custom attributes). A customizable fields module 806 which includes basic customizable fields specific to different IP asset types for detailed record-keeping. A customizable workflows module 808 includes an ability to customize internal and external workflows, with pre-built workflow templates for specific IP assets. An annuity management module 810 with a capability to configure custom reminders for tracking annuity payments to avoid missed deadlines. An administrative dashboard module 812 configured to aggregate tenant-level state data, workflow execution status, and system event logs for centralized monitoring. An audit logs module 814 configured to generate immutable records of configuration changes, tenant provisioning events, workflow modifications, access policy updates, and administrative actions for compliance and traceability. Configuration events initiated through the administrative panel 800 propagate to the workflow management module, security module 1700, financial module 1600, and trade secret vault subsystem 2000 to ensure consistent enforcement of tenant isolation and document governance policies.

FIG. 9 discloses an IP service management module 900. The IP service management module 900 governs lifecycle state management, metadata persistence, jurisdictional compliance tracking, and workflow association for various types of intellectual property (IP) assets as follows. A patents module 902 which stores and tracks patent information, including application number, filing date, status, and deadlines for renewals and maintenance fees. The patent module 902 is capable of handling different types of patents (e.g., Patent Cooperation Treaty (PCT), Utility Patent, Design Patent). A trademarks module 904 records and manages trademark details, such as registration number, filing date, owner, status, renewal dates, trademark classes and jurisdictions. A copyrights module 906 which records and manages copyright details, including registration number, type (e.g., audio, video, written copy, etc.), and jurisdictions, including the tracking of copyright status and renewal periods. An industrial designs module 908 is capable of managing design registrations, including design descriptions, classifications, and expiration dates. It also monitors status updates and renewal requirements. A custom attributes module 910 has the ability to define content management system (CMS) style custom attributes to each class of IP that can later be populated manually via the platform or import mechanism 804. Each IP asset record maintained by module 900 is programmatically associated with jurisdiction-specific renewal rules and workflow templates, enabling automatic instantiation of lifecycle workflows upon asset creation or status change.

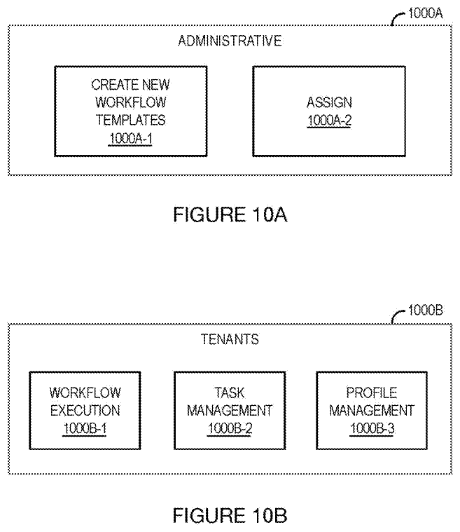

FIGS. 10A-10B disclose workflow management modules: an administrative module 1000A and a tenants module 1000B. These modules support the ability to define visual, template-based workflows for a specific IP type. Module 1000A-1 creates new workflow templates which visually define a workflow that's associated with a specific IP type (e.g., patents, trademarks). Assign module 1000A-2 assigns workflow templates to a specific tenant, including support for internal or external workflows. Worflow execution module 1000B-1 IP type will follow a specific workflow based on tenant configuration. Task management module 1000B-2 allows for the ability to define tasks as part of a specific IP request. Profile management module 1000B-3 allows for the ability to populate a profile, including a biography, profile picture, and description for each profile.

FIG. 11 discloses a collaborative laboratory notebook module. Lab notebook module 1100 discloses a digital, collaborative lab notebook that enables users to document, organize, and manage research notes and findings in a structured format. This notebook serves as the foundation for creating IP documentation by seamlessly converting entries into draft filings for patents, trademarks, copyrights, and more. In module 1100, there is a rich text editor module 1100A which is a versatile editor that supports text, images, tables, equations, and attachments. The module 1100A allows users to create detailed, structured research notes and records. Templates and sections module 1100B provides customizable templates for different types of IP (e.g., patents, copyrights) and specific research needs, ensuring consistency in data entry. Folder and search functionality module 1100C allows users to organize their entries into folders and quickly search and filter documents by keywords, tags or dates. The module 1100 supports a structured conversion flow: research capture in the notebook, AI-driven structured extraction of key elements, generation of draft filings, and routing to workflows for agent review.

FIG. 12 discloses an intellectual property maintenance module 1200 which focuses on managing renewals with integrated government systems to ensure continuous IP protection. IP renewals 1200A has i) reminders and alerts which set reminders for upcoming renewals and overdue payments to ensure continuous IP protection and ii) periodic government checks which automate periodic checks with integrated government systems (e.g., United States Patent & Trademark Office (USPTO), Saudi Authority for Intellectual Property (SAIP)) to verify the status of IP filings and detect any updates or changes. In addition, the system 100 also monitors automated renewal deadlines. Notifications module 1200B has customizable notifications which notify relevant tenants and users of expiring IPs, overdue renewals, or any changes in status and allows for customization of notification preferences (e.g., email, SMS integration via Unifonic or similar). The notifications module 1200B also sends critical alerts for IP requiring immediate action such as those nearing the end of the renewal grace period. Payments and renewals module 1200C has i) renewal flow which enable one-click renewal payments for IP assets, leveraging an integrated payment gateway (TAP Payments) to streamline the process and ii) automated workflow transitions which automate the transition of IP status within the platform based on the filing department's updates (e.g., from “Pending Renewal” to “Active” once the renewal is processed). Payment tracking and history module 1200D has a track payment history which maintains a comprehensive record of all renewal payments. These renewal payments include payment methods, amounts, and dates and generate financial reports which provide tools to generate detailed reports of all payments related to IP renewals for accounting and audit purposes. Government filing integrations module (1200E) has direct integration with IP offices (e.g., USPTO, SAIP) to retrieve the status of IP assets (the scope includes two office integrations). The government filing integration module also monitors legal compliance to ensure all IP renewals comply with the specific rules and deadlines of each jurisdiction. Maintenance Mode Management Module (1200F) allows for periodic status verification: The system 100 performs automated, scheduled checks against government IP offices (e.g., USPTO, SAIP) to detect updates, even in the absence of traditional APIs. The module 1200F also manages expired IPs to allow clients to manage and take action on expired IPs, such as reinstating, opting out of renewal, or marking as “not renewed.” Fee schedules module 1200G configures fee schedules by IP type so that invoices and actions become due depending on the configured fee schedule. The computer system and method 100 also periodically verifies statuses with government offices in fragmented jurisdictions and automatically transitions workflows based on verified updates or payment confirmations. The platform 100 addresses the risks of asset expiration through the automated IP maintenance module 1200 configured for fragmented jurisdictions. The system 100 has automatic workflow transitions. When a status change is verified (e.g., “Published” to “Granted”), the system 100 automatically updates the internal workflow state and triggers necessary notifications. Further, there is bifurcated financial management. The financial management module processes renewal payments while strictly separating government fees from IP agent fees, ensuring transparent accounting and payment execution.

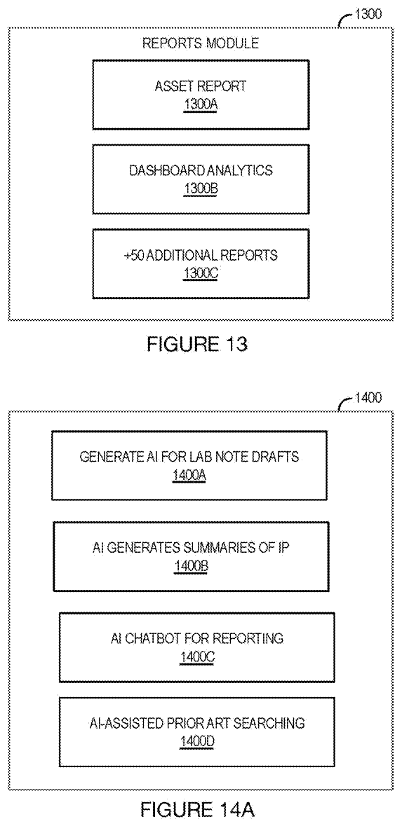

FIG. 13 discloses a reports module 1300 which provides analytics and visualizations to help users gain insights into their IP portfolio performance. Examples include the following. asset report 1300A which visualizes assets based on all of the various attributes with export options (csv). Dashboard analytics 1300B help visualize key metrics such as total IP assets and upcoming renewals. The reports module 1300 It can generate up to fifty plus additional structured reports 1300C as needed. The module 1300 separates government fees from IP agent fees for accurate accounting and automates status transitions upon payment confirmation or verified office updates.

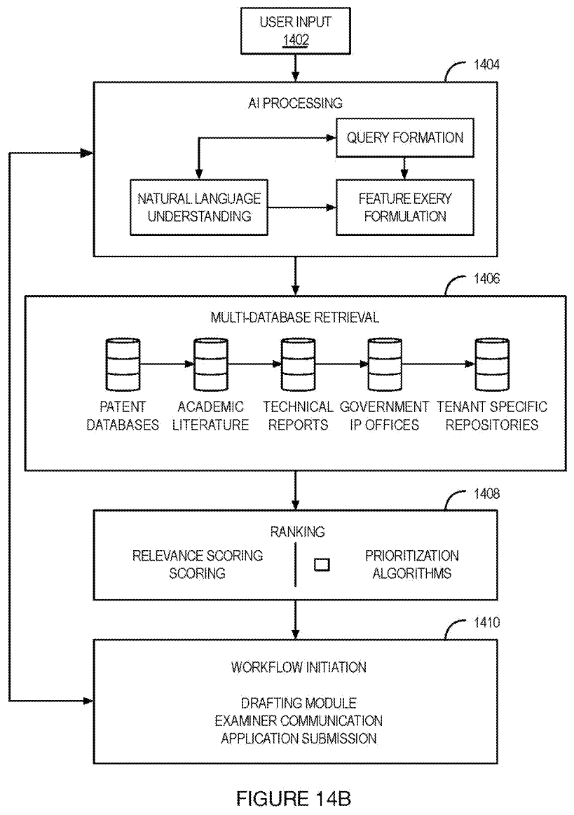

FIG. 14A discloses artificial intelligence module 1400 which integrates generative Al tools (as discussed above in relation to FIGS. 3-6) to enhance the IP management process, specifically via integrations with one or more generative artificial intelligence services.. Generative Al for lab note drafts module 1400A utilizes generative Al to automatically convert submitted lab notes and technical descriptions into structured, initial drafts suitable for IP filing. This process provides IP agents with a solid starting point for creating comprehensive IP documentation. Al generates summaries of IP in module 1400B to get Al-based summaries of drafts and IP filing information. An Al chatbot for reporting module 1400C is used for implementing an Al-powered chatbot that allows users to request and receive real-time analytics and reports through a conversational interface thereby simplifying access to complex data. AI-assisted prior art search 1400D allows for the following functionality: 1) searching across the internal structured database of the entire system 100; 2) the integrated government IP databases (e.g., USPTO, SAIP, etc.); 3) public patent and non-patent literature databases; 4) customer or tenant-specific internal databases; and 5) free form searches across the Internet. In operation of module 1400D, a user inputs a problem statement and provides contextual information defining the invention scope (technical field, constraints, embodiments, etc.). The AI module 1400D then searches one or more selected databases-potentially simultaneously-including integrated government systems, public patent databases, non-patent literature repositories, tenant-specific data environments and a free from search across the Internet. The AI module 1400D performs semantic matching and relevance ranking and returns prioritized (score for relevance) references before a filing workflow is initiated. FIG. 14B illustrates an AI-assisted prior art search flow including user input 1402, AI processing 1404, multi-database retrieval 1406, ranking 1408, and workflow initiation 1410.

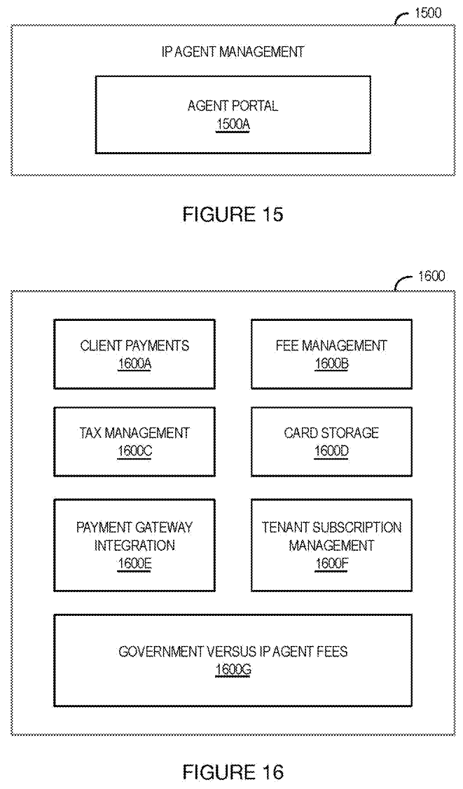

FIG. 15 discloses IP agent management module 1500 which manages interactions between clients and agents, supporting multi-tenancy and role-based access. Agent portal module 1500A enables agents to manage client requests, handle IP services, and securely communicate with clients. This ensures that agents have secure role-based access control with strict access to a portion of the information. The module enforces tenant isolation, limited visibility based on roles, and full audit trails for all actions.

FIG. 16 discloses a financial management module 1600. The financial management module 1600 handles all financial transactions related to IP renewals, licensing fees, and annuity payments. The financial management module 1600 includes the following functionalities. Client payments 1600A manages payments for IP services, including invoicing and tracking. Fee management 1600B defines processing fees that are charged to IP service payments. Tax management 1600C includes tax in IP service payments, specifically as it relates to revenue and service fees. Card storage 1600D saves a credit card(s) and supports renewal payments. Payment gateway integration 1600E manages integration with tap payments with Apple Pay™. Tenant subscription management 1600F manages recurring subscriptions for clients with online payment options and recurring billing. Government versus IP Agent Fees 1600G manages the ability to define fees as government fees versus IP agent fees and account for them accordingly.

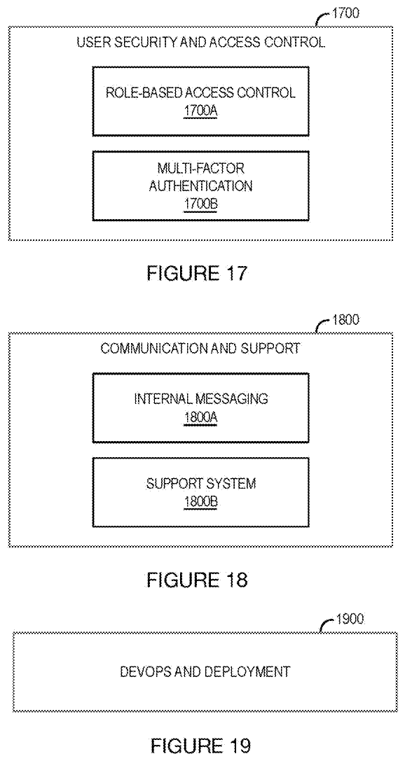

FIG. 17 discloses user security and access control module 1700. The module 1700 includes a role-based access control 1700A to implement essential role-based access controls for different user levels. The module 1700 also includes multi-factor authentication 1700B to introduce basic multi-factor authentication for added security using email one time passwords (OTPs) and support for authenticator-style code generators.

FIG. 18 discloses a communication and support module 1800. Module 1800 enables communication between users and their clients as it relates to specific pieces of IP. Internal messaging module 1800A enables secure messaging between clients, agents, and administrators. Support system module 1800B manages integration with existing ticketing and support system and help desk.

FIG. 19 discloses development and operations (devops) and deployment module 1900. Devops is the integration and automation of the software development and information technology operations. Devops is a set of practices, culture, and tools that integrates software development and information technology (IT) operations to shorten the development lifecycle and improve software delivery through continuous collaboration and automation. For example, deployment to Saudi-based host with a containerized architecture to comply with data residency requirements. The computing system and method 100 enforces a controlled collaboration model to protect sensitive intellectual property. The system 100 has agent portal isolation. IP agents are granted access via a dedicated portal. Role-Based Access Control (RBAC) ensures agents only see the specific tasks and documents assigned to them within a tenant's isolated environment. There is also conversational reporting. A conversational AI chatbot allows authorized users to request real-time analytics (e.g., “What is my total renewal liability for Q3?”) through a secure interface. The system 100 has immutable audit trails. Every interaction-from AI-generated draft edits to agent access attempts-is logged immutably to ensure compliance and data residency requirements (e.g., Saudi-based hosting for local data sovereignty).

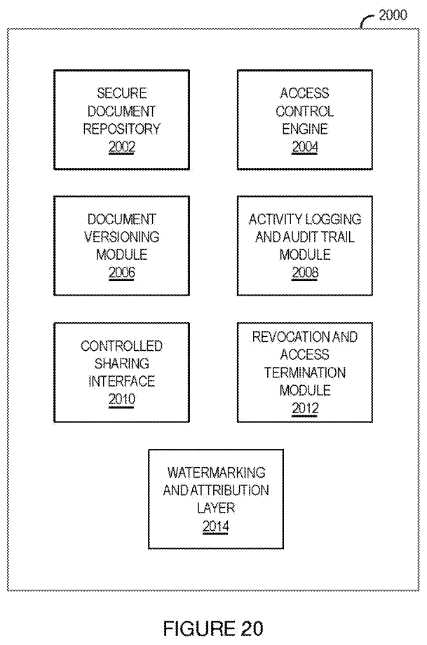

FIG. 20 discloses a trade secret vault subsystem 2000 with controlled access and audit tracking. The core components include a secure document repository 2002 for encrypted storage of trade secret documents, metadata tagging (e.g., classification, project, department) and versioned document storage. Subsystem 2000 further includes an access control engine 2004 for role-based access control, attribute-based access policies (optional), conditional access logic (e.g., NDA/agreement status, employment status), and time-based access constraints. Document versioning module 2006 has a version creation upon modification, immutable prior versions, change delta tracking, and rollback capability. Activity Logging & Audit Trail Module 2008 has log access events (view/download/share/edit), timestamp and user identity tracking, immutable audit record storage and administrative review interface. Controlled Sharing Interface 2010 internal sharing within tenant, external sharing to agent portal users, access expiration controls, and permission scoping (e.g., view-only, comment-only, edit). Revocation and access termination module 2012 has real-time revocation of access, automatic revocation upon role change or policy violation, and access state synchronization across sessions. Watermarking and attribution layer 2014 has user-embedded watermark overlays, download-specific identifiers, And evidence tagging for forensic traceability.

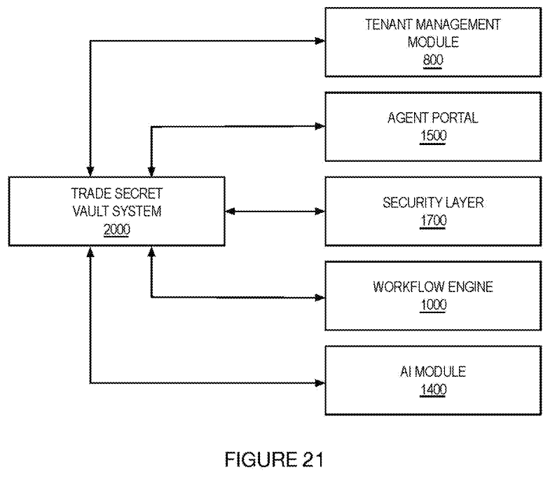

FIG. 21 shows the trade secret vault system 2000 interaction with other modules in the system 100. Vault system 2000 interacts with the Tenant Management Module (800 series), Agent Portal (1500 series), Security Layer (1700 series), Workflow Engine (1000 series) and AI Module (1400 series) (if applicable for document summarization or classification)

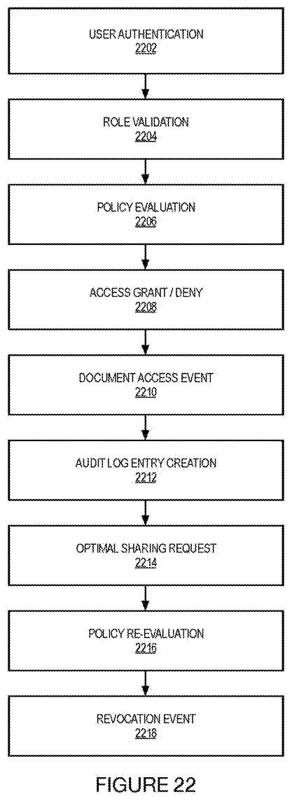

FIG. 22 discloses the trade secret vault access workflow. From user authentication 2202, role validation 2204, policy evaluation 2206, access grant/deny 2208, document access event 2210, audit log entry creation 2212, optional sharing request 2214, policy re-evaluation 2216 and revocation event 2218.

In summary, the trade secret vault subsystem 2000 is a centralized vault for securing trade secrets. Specifically, the trade secret vault system 2000 is a secure repository to store sensitive, non-patented IP like formulas, algorithms, and business methods. Access is based on policy controls: user access can be granted or restricted based on NDAs, employment contracts, or internal approvals workflows. The vault subsystem 2000 has an audit trail and monitoring: every access attempt, download, and change is tagged, ensuring accountability and traceability. The vault subsystem 2000 has customizable roles and permissions: fine grained controls over who view, edit, or share each record. The vault subsystem 2000 is integrated with IP workflow: connects with the broader ecosystem 100 to manage the full lifecycle of innovation, from idea to secrecy to protection. In the context of a high-tech patent application or a secure intellectual property (IP) management system, this phrase describes the automated “gatekeeper” that controls who can see a trade secret and what happens to that secret over time. The vault subsystem 2000 uses conditional and dynamic access logic. This refers to access control that is not static (like a simple password). Instead, it uses if/then rules to grant entry:
Conditional: Access is granted only if certain criteria are met (e.g., “The user must be on the internal company network” or “The user must have a ‘Top Secret’ clearance level”).
Dynamic: The rules can change in real-time. For example, if a suspicious login attempt is detected from an unknown location, the system can automatically lock the “vault” even for authorized users until identity is re-verified.
   There is also revocation (i.e., kill switch). If an employee leaves the company or a project is canceled, the system can instantly pull back access. Unlike a physical document that could be photocopied, this digital revocation ensures the trade secret is no longer viewable or downloadable by that specific user, regardless of their previous permissions. There is lifecycle transition to filing workflows in the moment a company decides to stop keeping a secret hidden and instead applies for a patent. Trade secrets rely on absolute secrecy; patents rely on public disclosure. This logic manages the tipping point (or transition). When a project reaches a certain maturity level (the “lifecycle”), the system automatically triggers a workflow (i.e., automation). It might move the data from the secure vault directly to a drafting module where lawyers begin the patent application process.

The computing system and method 100 brings together innovators, administrators, and IP agents to collaborate efficiently within one smart ecosystem. Each role is supported by customized dashboards, intelligent workflows, and AI-powered tools configured to optimize their specific tasks. Users move through the system 100 from idea generation to filing, management, and IP protection, ensuring clarity and control at every stage. Real-time updates, shared access, task management, and communication tools, promote transparency, teamwork and faster execution. The computing system and method 100 streamlines the entire innovation cycle capturing, nurturing, managing and safeguarding intellectual property.

After signing into system 100, the user lands on a smart feed that connects with fellow innovators. The user is able to post updates, share milestones, or comment on other researchers work. The user is able to stay aligned and engaged with the internal innovation network. The user is able to access all tasks, updates and notifications and get an instant overview of pending requests and mentions. The user is able to deep dive into each task by clicking at it, upload documents, set IP reference, numbers and status to ensure that task is logged and traceable.

The system and method 100 is a a centralized research workplace. It is able to store all research, notes, drafts and experimental results in a documents section. The system is able to create folders by type: patents, trademarks, and copyrights. The system 100 is able to navigate, search, and organize documents.

The system 100 allows the user to start a new research entry in seconds, use a quick form to name and describe a research document., and save progress instantly and build case as the user goes.

The system 100 features AI powered research and visual support. The AI helps source verified research articles and summarize findings. The AI auto-generates supporting visuals to strengthen concepts and fuels deeper, smarter innovation. AI summarizes request content, saves time on reading full request history. Key for high-volume administrative work.

The system 100 allows for simplified filing with ready templates. The system 100 allows the user to browse IP templates for patents, trademarks, copyrights and more. The system 100 allows the user to be inspired by stored filing formats and save time on drafting.

The system 100 allows for the entering of request details using structured fields and dropdowns. The user can upload files, assign collaborators, and set timelines with ease.

The system 100 allows the user to have full visibility over filing progress. Timelines show every phase of the submission. Real-time updates help the user follow up when needed. There is centralized collaboration in every IP card. The user can upload relevant documents (e.g., photos, financials, drafts). The user can leave comments for specific milestones or collaborators.

The system 100 includes IP lifecycle tracking. The system 100 provides real-time visibility in the status of all intellectual property assets, from ideation to through registration and renewal. The system 100 will automatically post reminders and alerts for deadlines, renewals, and key IP actions. The system 100 will streamline and securely handle payments for renewals directly through the platform.

The system 100 includes filing information all in one tab. The user is able to view full filing history, statuses, agent notes, and jurisdiction information. The user never loses track of key legal details.

The system 100 includes organized documentation. Centralized e-notebook for idea capture and development. Seamless team management—enable collaboration, task assignment, secure communication, and coordination to keep your team aligned on IP policies and processes. The system 100 includes AI-Driven Insights including intelligent research support. Automated templates including simplified documentation formats. Streamlined workflow system—automated internal IP task handling.

The system 100 includes streamlined workflows, real-time updates, AI insights, and data analytics, and enhanced efficiency.

The system 100 is able to manage IP agent organizations. Add new agent organizations with reference numbers. Invite agents via email, assign their roles and track invitation statuses. Role based control for better data governance.

Agent overview and roles. Central view of all agents. See who is active, roles and statuses. Maintain clarity on team capacity and structure.

Live dashboards for real-time oversight. Access comprehensive data view. Track IP compliance, job creation, and sector-specific information. View organization structure with all sub-organization. Drill down into individual organizations and view specific metrics, which ensure IP pipeline is transparent.

Submitting and managing IP requests. Choose request type: patents, trademarks, copyrights. Enter agent, organization, priority, and deadline. Manage requests by tracking priority, status, agents, deadlines, which can be filtered and organized.

Request details view and collaboration. Access cards for each request and service type, pricing, and deadline linked to reference IP. Assigned teams can leave comments, tag users, attach files and assign sub-tasks. Ensure clear and smooth communication.

Initiating new IP requests. Administrators can start fresh or import existing data. It centralizes the creation of new IP requests of any type. By filing out IP type, assignees, description and attached related documents. This streamlines the submission workflow.

Viewing IP office data. Full metadata on IP submissions. Jurisdiction, filing dates, approvals and codes. Central reference for legal and administrative information.

Track requests visually with smart boards. View all your IP requests in one place using a real-time, color-coded board. Collaborate smoothly with full visibility across all requests and teams. Stay aligned with priorities and never miss a deadline.

Instantly search global databases for relevant prior art, streamlining the patentability evaluation. Quickly identify similar patents and categorize results by relevance and potential conflicts. Leverage AI-generated summaries and insights to accelerate decision-making and strengthen patent applications.

Annuities and Renewals Management. Centralize tracking of upcoming IP annuities and renewal deadlines to maintain compliance effortlessly. Receive automated reminders to ensure timely action, preventing any lapses or expirations. Simplify the renewal payment process directly with the system ensuring secure and efficient transactions.

A trade secret vault subsystem 2000 configured to store, govern, and monitor confidential intellectual property assets that are not publicly filed. The vault subsystem maintains encrypted document repositories within tenant-isolated storage environments and enforces document-level access control policies based on role assignments, contractual conditions, workflow states, and approval hierarchies. The vault subsystem 2000 records immutable audit events for each access attempt, modification, download, permission change, and sharing action associated with a stored document. Each document is associated with version identifiers and change histories, enabling traceable document evolution over time. Access to vault-stored documents may be conditionally granted based on satisfaction of predefined policy rules, including non-disclosure agreement status, employment status, approval workflows, and role-based authorization. The vault subsystem is programmatically integrated with the workflow management module and artificial intelligence module such that AI-generated drafts and collaborative notebook entries are stored as governed vault documents prior to submission to external filing systems. The vault subsystem 2000 thereby supports controlled transition of intellectual property assets from confidential trade secret state to publicly filed patent or trademark state, while preserving audit integrity and access traceability. In some embodiments, document-level access policies are evaluated dynamically upon each access request and may prevent inference of document existence by unauthorized users.

Interactive dashboards. Real-time portfolio display with 360 degrees visibility. Idea and IP analytics: extract data analytics and actionable insights for more intelligent decision-making. Customizable workflow: tailer end-to-end workflow management tool. Data integration: seamless ingestion of multiple data sources. Control of idea and IP management: transform, organize, and optimize idea and IP workflow, management and lifecycle with powerful tools.

Seamless collaboration with teams to ensure timely transactions. IP agent dashboard. See all assigned tasks and their status. Stay on top of deadlines with latest requests sorted by priority. Notifications keep you in the loop with any mentions or updates.

Reviewing a new request. Access all relevant request information in one view type, deadlines, reference IP. Take action by marking as completed or declining with a reason. Collaborate easily using tabs for attachments, comments and tasks.

Setting the service price. Add pricing specific for each request. Option to set a default for that type of service. Keep pricing standardized for future. Keeps pricing standardized for future requests.

Managing pricing across all services. Set and update prices for various service types. Automatically reflected in administrative and creator dashboards. Ensures clarity and transparency for all stakeholders.

Aspects of the disclosure further include a computer-implemented method for assisting prior art analysis in an intellectual property management platform, comprising: receiving a problem statement and invention scope parameters associated with a proposed intellectual property asset; retrieving references from one or more integrated government databases, public patent databases, non-patent literature databases, or tenant-specific repositories using an artificial intelligence model; computing semantic similarity or relevance scores between the invention scope parameters and the retrieved references; and presenting ranked prior art references to a user prior to generation or submission of a filing workflow.

Aspects of the disclosure further disclose a computing system for intellectual property (IP) management, comprising: one or more processors and non-transitory computer-readable media storing instructions that, when executed, cause the system to implement: an IP agent management module that includes a dedicated agent portal; a controlled collaboration model executed within the agent portal, wherein the controlled collaboration model is configured to enable secure, role-specific interaction between IP agents and one or more tenants while enforcing strict controlled access boundaries, the boundaries comprising: (a) multi-tenant isolation, wherein data, workflows, documents, and communications belonging to any one tenant are stored and processed in a logically and physically segregated environment that is inaccessible to agents or users associated with any other tenant; (b) role-based access control (RBAC), wherein each agent is assigned one or more discrete roles including a filing agent, renewal specialist, and portfolio reviewer and is granted permissions only to the specific IP assets, workflows, tasks, and client communications that are explicitly assigned to that agent and that tenant; (c) limited visibility, wherein the agent portal displays to each agent only the subset of tenant information, documents, status data, payment records, and audit entries that is necessary for the performance of the agent's assigned role and assigned tasks, while automatically redacting or hiding all other tenant data, including data belonging to other tenants and non-relevant data within the same tenant; and(d) full auditability, wherein every action performed inside the agent portal is automatically and immutably logged with timestamp, actor identity, role, tenant identifier, IP asset reference, and before and after values, and the resulting audit trail is stored in a tamper-evident repository accessible only to authorized administrators. The system described above wherein the controlled collaboration model further comprises: a unified request card interface inside the agent portal that aggregates, for each IP service request, all attached files, threaded comments, sub-tasks, deadlines, pricing, and real-time status updates; and real-time collaboration controls that permit agents and authorized tenant users to post comments, tag participants, attach documents, and assign sub-tasks, all subject to the same role-based access, tenant isolation, limited visibility, and auditability constraints of the agent portal. The system described above wherein the agent portal further includes an agent dashboard that surfaces only those pending requests, deadlines, and notifications that are assigned to the logged-in agent across all authorized tenants, sorted by priority, and wherein any export or report generated from the dashboard is automatically watermarked with the agent's identity and the specific tenants to which the data pertains. The system described above wherein the audit trail generated by the controlled collaboration model is queryable by tenant, by agent, by IP asset, and by date range, and is configured to produce compliance reports that separate government fees from IP-agent service fees while preserving tenant isolation.

The foregoing embodiments are presently by way of example only; the scope of the present disclosure is to be limited only by the following claims.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments were described as processes. Although these processes may describe the operations as a sequential process, many of the operations can be performed in parallel or concurrently. In addition, the order of the operations may be rearranged. A process may have additional steps not included in the figures. Also, a number of steps may be undertaken before, during, or after the above elements are considered.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Accordingly, the above description does not limit the scope of the disclosure.

The foregoing has outlined rather broadly features and technical advantages of examples in order that the detailed description that follows can be better understood. Additional features and advantages will be described hereinafter. The conception and specific examples disclosed can be readily utilized as a basis for modifying or designing other structures for carrying out the same purposes of the present disclosure. Such equivalent constructions do not depart from the spirit and scope of the appended claims. Features which are believed to be feature of the concepts disclosed herein, both as to their organization and method of operation, together with associated advantages, will be better understood from the following description when considered in connection with the accompanying figures. Each of the figures is provided for the purpose of illustration and description only and not as a definition of the limits of the claims.

Devices or modules that are described as in “communication” with each other or “coupled” to each other need not be in continuous communication with each other or in direct physical contact, unless expressly specified otherwise. On the contrary, such devices need only transmit to each other as necessary or desirable, and may actually refrain from exchanging data most of the time. For example, a machine in communication with or coupled with another machine via the Internet may not transmit data to the other machine for long period of time (e.g. weeks at a time). In addition, devices that are in communication with or coupled with each other may communicate directly or indirectly through one or more intermediaries. When elements are referred to as being “connected” or “coupled,” the elements can be directly connected or coupled together or one or more intervening elements may also be present. In contrast, when elements are referred to as being “directly connected” or “directly coupled,” there are no intervening elements present.

What is claimed is:

1. An intellectual property (IP) management system comprising:
a tenant management module configured to provision isolated data environments for a plurality of tenants and enforce tenant-level data segregation;
an IP service management module configured to persist IP asset records including jurisdiction-specific attributes, lifecycle states, deadlines, and renewal requirements;
a workflow management module configured to instantiate and execute workflow instances associated with the IP asset records;
a maintenance module configured to monitor renewal conditions for the IP asset records by querying one or more government intellectual property office systems and automatically initiate renewal workflows based on detected renewal events;
a financial management module configured to process payments associated with the renewal workflows and associate payment transactions with corresponding IP asset records; and
an artificial intelligence module configured to generate draft IP filings and analytics based on tenant-isolated data.

2. The system of claim 1, wherein the artificial intelligence module is further configured to convert structured research entries stored in a digital laboratory notebook module into draft intellectual property filing documents.

3. The system of claim 1, further comprising:
a maintenance module configured to monitor renewal deadlines for the IP assets, communicate with external IP office databases, and process annuity and renewal payments for the IP assets through an integrated payment gateway.

4. The system of claim 1, further comprising:
an analytics module configured to generate portfolio reports and dashboards across the plurality of tenants.

5. The system of claim 1, further comprising:
wherein the system is deployed on a containerized cloud architecture configured to comply with regional data residency requirements.

6. The system of claim 1, wherein the IP service management module is configured to define custom metadata fields for each of the plurality of IP assets.

7. The system of claim 1, wherein the instructions further cause the system to:
periodically query remote government IP office databases in a plurality of fragmented jurisdictions to retrieve real-time status data for the imported IP asset data;
verify the retrieved real-time status data against the jurisdiction-specific attributes; and
automatically update a workflow state from a first status to a second status based on the verification, wherein the automatic update triggers at least one of a task assignment or an automated notification to a user within the isolated tenant environment.

8. The system of claim 1, further comprising a financial management module configured to process renewal transactions for the IP asset data, wherein the instructions further cause the system to:
bifurcate a total renewal cost into a government fee component and an intellectual property agent fee component;
execute a payment via an integrated payment gateway using saved payment information associated with the isolated tenant environment; and
generate a financial report within the isolated tenant environment that distinguishes the government fee component from the IP agent fee component for accounting and audit purposes.

9. The system of claim 1, further comprising a collaborative lab notebook module featuring a rich text editor configured to capture the research inputs, wherein the AI integration further comprises instructions to:
perform structured extraction of technical elements from the research inputs captured in the lab notebook module;
generate the draft IP filing based on the extracted technical elements; and
route the draft IP filing into a specific workflow template assigned to an IP asset type selected from a group consisting of patents, trademarks, copyrights, and industrial designs for review by an assigned agent.

10. The system of claim 1, further comprising an agent portal module configured to provide an assigned agent with a dedicated interface to interact with the isolated tenant environment, wherein the enforcement of secure collaboration further comprises:
applying limited visibility constraints within the agent portal to restrict the assigned agent to viewing only a subset of the IP asset data required for a pending task;
enforcing tenant isolation to prevent the assigned agent from accessing data in non-assigned tenant environments; and
maintaining the immutable logs by tagging every access attempt, data modification, and communication performed by the assigned agent within the agent portal.

11. The system of claim 1, wherein the artificial intelligence module is further configured to receive a problem statement and invention scope parameters from a user, retrieve patent and non-patent literature from one or more selected external and internal databases, generate semantic representations of retrieved references, and rank the references based on relevance to invention scope parameters.”

12. The system of claim 1, wherein the artificial intelligence module is configured to compare extracted technical features of a proposed intellectual property asset against features of retrieved prior art references to identify potential novelty or patentability risks prior to initiating a filing workflow.

13. The system of claim 1, further including a trade secret vault subsystem comprising:
a secure document repository for encrypted storage of trade secret documents;
an access control engine configured to enforce access policies;
a document versioning module;
an activity logging and audit trail module;
a controlled sharing interface; a revocation module; and
a watermarking and attribution layer.

14. The system of claim 13 wherein the access control engine is configured to enforce role-based access control combined with conditional access logic including verification of non-disclosure agreement (NDA) status, current employment status of a user, other forms of conditions verified by other agreements, and time-based access constraints that automatically expire access after a predefined duration.

15. The system of claim 13 wherein the revocation and access termination module is configured to perform real-time revocation of access rights in response to at least one of: a manual administrative command, an automatic trigger upon detected policy violation, or a role change of a user, and wherein the module synchronizes access state changes across active user sessions to immediately terminate unauthorized access to encrypted trade secret documents stored in the secure document repository.

16. The system of claim 1, wherein outputs generated by the artificial intelligence module are evaluated against tenant-level access control policies prior to storage or external transmission.

17. A computer-implemented method for managing intellectual property (IP) assets in a multi-tenant platform, comprising:
provisioning isolated tenant environments with customizable workflows and attributes;
importing a plurality of IP assets into the tenant environments from structured file formats;
storing and tracking the plurality of IP assets by asset type, jurisdiction, and renewal deadline;
defining and executing workflow templates associated with each of the plurality of assets;
recording research data in a digital notebook and converting said research data into draft IP filings using an artificial intelligence model;
monitoring renewal obligations by performing periodic automated queries to one or more government intellectual property office systems;
generating renewal workflow instances upon detection of an impending or confirmed renewal event;
processing renewal payments via an integrated payment gateway;
automatically transitioning a lifecycle state of the corresponding IP asset record upon confirmation of payment or government status update;
processing renewal payments via an integrated payment gateway; and
generating portfolio reports and analytics including artificial intelligence generated summaries of the plurality of IP assets.

18. The method of claim 17, further comprising:
managing secure interactions between tenants and IP agents through an agent portal with role-based access control.

19. The method of claim 17, further comprising:
monitoring renewal obligations by performing periodic queries to government IP systems; and
transitioning the status of each of the plurality of IP assets automatically upon confirmation of a renewal payment.

20. A trade secret management subsystem for an intellectual property management platform, comprising:
a tenant-isolated encrypted document repository configured to store confidential intellectual property assets;
a policy engine configured to apply conditional and dynamic access logic to enforce document level access controls based on real-time user attributes, environmental parameters, role assignments and predefined contractual conditions and revoke access to the document repository upon the occurrence of a predefined security event;
an audit module configured to record immutable audit events corresponding to access attempts, modifications, downloads, and permission changes associated with stored documents; and
a lifecycle transition module configured to initiate an intellectual property filing workflow in response to a controlled transition of a document from a confidential state to a public filing state.
